(19) United States
(12) Patent Application Publication
(10) Pub. No.: US 2026/0132041 A1
(43) Pub. Date: May 14, 2026

(54) MAGNESIUM CHLORIDE PURIFICATION SYSTEMS, DEVICES AND METHODS

(71) Applicant: MAGRATHEA METALS INC., San Francisco, CA (US)

(72) Inventors: Alexander GRANT, San Francisco, CA (US); Jacob BROWN, San Francisco, CA (US)

(21) Appl. No.: 19/118,444

(22) PCT Filed: Oct. 6, 2023
(86) PCT No.: PCT/US2023/076224

§ 371 Date: Apr. 4, 2025

Related U.S. Application Data
(60) Provisional application No. 63/414,201, filed on Oct. 7, 2022.
(60) Provisional application No. 63/499,350, filed on May 1, 2023.

(51) Int. Cl. C01F 5/32; C01F 7/62

(52) U.S. Cl. CPC C01F 5/32; C01F 7/62; C01P 2006/40

(57) ABSTRACT

The present technology relates to systems, devices and methods for the production of highly dehydrated and pure magnesium chloride and aluminum chloride.

### TECHNICAL FIELD

The present technology relates to methods and systems for the purification of magnesium chloride.

### BACKGROUND

Environmentally friendly purification of metal salt compositions such as feedstocks for metal production via electrowinning or chemothermic processes, particularly electrolytes comprising magnesium chloride and aluminum chloride, is desirable as industries seek to decarbonize their operations. Typical impurities, such as water of hydration, magnesium oxide and magnesium hydroxychloride or their aluminum counterparts are problematic in the production of metal via electrolysis as they attack the graphite electrodes used in the electrochemical cell causing degradation and need for electrode replacement. Over the years, people have tried many methods for the production of pure, anhydrous, magnesium and chloride feed materials but most have failed to be operated with commercial success or are extremely expensive to build.

The push for the decarbonization of the industrial economy necessarily entails the substitution of renewable energy sources for fossil-based electricity generation. A major segment of energy consumption is the production of structural metals. The smelting of steel has a large carbon footprint, and one key structural metal, aluminum, requires large quantities of electricity for its electrolytic production that consumes carbon anodes, producing carbon dioxide directly in production. Both steel and aluminum require significant mining of iron ore and bauxite in their supply chains, respectively, which has major social and environmental impacts.

Magnesium metal is an attractive alternative to aluminum and steel in structural metal applications because it has the highest strength to weight ratio of all major structural metals, meaning it can be used for lightweighting of structures in transportation applications. The feedstock for magnesium metal production can be economically extracted from seawater and brines, obviating the need for environmentally destructive mining, which is required in the production of bauxite, the principal aluminum ore, and for extraction of iron ore to make steel. Magnesium can be produced electrolytically, allowing the use of renewable and other low carbon electricity sources for its production. Magnesium electrolytic production does not directly emit carbon dioxide in the same manner as alumina cryolite electrolysis with carbon anodes, nor does it emit significant quantities of fluorinated compounds as occurs in aluminum production and are strong greenhouse gases, implying the production process can be more easily decarbonized. However, the production of electrolytic quality magnesium chloride is difficult and energy intensive due to the difficulty of removing waters of hydration and other oxygen containing compounds such as, but not limited to, magnesium hydroxide, magnesium hydroxychlorides, magnesium oxide, calcium hydroxide, calcium hydroxychloride, and calcium oxide, from magnesium chloride.

U.S. Pat. No. 5,593,566, incorporated herein by reference, discloses a complex electrolytic cell that utilizes a cathode and anode in order to allow for the use of magnesium electrolytes containing higher than normal amounts of magnesium oxide or other impurities. However, these cells need to be cleaned and maintained more often, a process that renders them inefficient to run. Thereby there is still a need for methods to simply and economically produce high purity feedstocks for electrowinning processes. This process also makes no reference to the residual hydroxychloride impurities that inevitably corrode the carbon anode.

In order to circumvent this undesired composition during dehydration many attempts have been made, some in commercial installations, to use dehydrating atmospheres containing enough HCl gas to prevent evolution of HCl from the salt being dehydrated.

Another approach to dehydration starts with ammonium carnallite (NH₄·MgCl₂·6H₂O), which is heated in two stages to drive off water and then to sublime NH₄Cl. Collection of NH₄Cl for recycle requires condensation, a difficult operation to carry out on a large scale.

Other methods utilizing double salts, such as carnalites have been disclosed as well, as in Kh. Strelets, Electrolytic Production of Magnesium, 1977, Keter Publishing House, Jerusalem Ltd. Translated from Russian, ISBN 0 7065 1567 6, incorporated herein by reference.

Another approach is known as carbochlorination, involving the combined action of carbon and chlorine gas on the melt. This method is expensive, as chlorine gas spargers require exotic materials of construction and add to the capital cost of such a project. The method also produces toxic byproducts, oxychlorocarbon compounds known as “dioxins”, and creates extensive environmental issues. It is also not a particularly robust method, and it is reported that, despite the challenges of conducting carbochlorination, practitioners of this method do not even achieve highly pure MgCl₂ salt feed for their cells and must “de-sludge” their electrochemical cells periodically due to remove the oxygenated compounds that make their way downstream.

The “best available technology” for magnesium chloride dehydration today is thought to be the Norsk Hydro HCl fluidized bed process wherein MgCl₂·2H₂O is treated at temperatures over 300° C. in a HCl gas environment. This process is thought to produce a highly pure MgCl₂ product with minimal hydrolysis but involves substantial capital investment and operational cost. Firstly, the dehydration vessels must be built from high-nickel steels like fluidized which substantially contributes to capital cost, and the general corrosivity of the conditions used mean that very substantial safety precautions and systems must be built and maintained. Secondly, keeping the HCl gas re-circulating in a loop requires a gas drying process where H₂O is pulled from the HCl working fluid before sending it back to the HCl fluidized bed. This drying process is very challenging and involves azeotrope breakers and extensive cooling to drop the water molecules out of the gas stream. Any form of nickel contamination has deleterious effects on downstream processes, making nickel-containing materials of construction undesirable.

A method of dehydrating MgCl₂·6H₂O to obtain MgCl₂·4H₂O in the form of free-flowing flakes by concentrating a MgCl₂ solution above 169° C. and cooling the concentrate on a water-cooled revolving drum is described in the U.S. Pat. No. 2,871,428, incorporated herein by reference. However, the resulting tetrahydrate is not suitable for direct use in the typical magnesium electrowinning process since it contains too much water.

A method of dehydrating MgCl₂ by slow, batchwise or continuous addition of MgCl₂·6H₂O to a resistively heated bath of anhydrous MgCl₂/KCl is described in U.S. Pat. No. 1,903,592, incorporated herein by reference. However, while stating that this material is directly suitable for the electrowinning of magnesium, this disclosure provides a material that still contains unspecified amounts of MgO and MgOHCl.

An adaptation of the process disclosed in U.S. Pat. No. 1,903,592 is disclosed in U.S. Pat. No. 3,564,722, incorporated herein by reference, where the hydrous MgCl₂ is continuously dropped onto a layer of molten anhydrous MgCl₂ fused salts carried on an elevated fluid launder before being deposited through a venturi into a furnace pot. Again, no mention is made of the MgO and MgOHCl content of the resulting material or reference to how MgO or MgOHCl should be removed from this anhydrous MgCl₂.

DE 450469, incorporated herein by reference, describes a method of utilizing MgCl₂·xH₂O, up to x=6 by direct introduction into the anode compartment of a magnesium electrowinning cell where the dehydration takes place in an area of high concentration of chlorine which is said to mitigate the hydrolysis of MgCl₂ to MgO and MgOHCl. However, this process still produces relatively large amounts of these hydrolyses products and necessitates frequent cleaning of the cells, furthermore, the chlorine generated by this process is contaminated with water and HCl and is not commercially valuable.

U.S. Pat. No. 4,981,674, incorporated herein by reference, discloses a complex process that utilizes a carbon monoxide and chlorine gas mixture to remove oxygen from molten magnesium chloride as carbon dioxide and magnesium oxide however this requires a three-phase reaction of solids, liquids, and gases and extremely toxic carbon monoxide gas thereby is not optimal. This process also produces dioxin materials.

The present technology provides for a process that avoids the complexity of the other processes in use today by taking advantage of the water flash reaction of molten materials with MgCl₂·2H₂O or other hydrated forms of MgCl₂. For example, when MgCl₂·2H₂O is contacted with molten salt, most of it becomes MgCl₂ liquid. Some does hydrolyze and become either MgO or MgOHCl, but most of the oxygen containing material is solid, dense, and will sink to the bottom of the molten salt chamber. However, in contrast to MgO, MgOHCl is substantially more soluble in the molten salt electrolyte and will migrate to the carbon anodes of an electrolysis system where it will react with the surface and degrade it, thereby it is particularly advantageous to provide for simple and economical methods of reducing the MgOHCl content of electrolytes for the production of magnesium metal via electrowinning.

In the case of application of the present technology to the purification of magnesium salt comprising electrolytes, without wishing to be bound by theory, the following equation is thought to describe the process:

$$2 MgOHCl ( s ) + Mg ( l ) -> {MgCl}_{2} ( l ) + 2 MgO ( s ) + {H}_{2} ( g ) \qquad Equation 1$$

In such a reaction, residual MgOHCl species are re-converted into viable feed salt as MgCl₂ or made benign via conversion to the insoluble MgO via reaction with a metal. This MgO then settles out of suspension and can be separated, allowing the production of relatively much purer MgCl₂ electrolytes. This operation is referred to herein as “gettering”

Other methods of further purification of the electrolyte feedstocks or electrolytes themselves may involve the reaction of the feedstock or electrolyte with a metal.

U.S. Pat. No. 6,676,824, incorporated herein by reference, discloses an electrolytic process for the purification of molten magnesium chloride electrolytes that electrolytically produces small amounts of magnesium metal that further reacts with the contained impurities. However, these approaches involve adding complexity to the magnesium production process. In one case, adding an extra electrolytic processing step, in the others, greatly increasing the complexity of the dehydration and pre-treatment process. Thereby, there is a need for devices, methods, compositions, and systems for the production of magnesium metal from magnesium salts without the use of complex energy and reagent intensive isolation and purification processes.

The present technology provides an alternative method of obtaining electrolyte compositions comprising magnesium chloride suitable for the electrolytic production of magnesium metal that can be made from crude magnesium chloride, as well as for the production of other metals such as aluminum.

### SUMMARY

The electrolytic production of magnesium metal from a magnesium chloride feedstock requires that the MgCl₂ feedstock be of high purity. In particular, oxygen in the form of H₂O, Mg, Mg(OH)₂, or MgOHCl, is detrimental to the electrolytic process and causes several complications. The production of corrosive gasses such as HCl and steam which damage equipment and make the Cl₂ gas produced unsellable. The production of compounds which are insoluble in the electrolyte. These accumulate, forming a sludge that needs to be removed. Stopping the operation and cleaning the electrolytic cell is time consuming and costly, often requiring human labor. Oxygen compounds disrupt the electrolyte circulation patterns. Oxygen compounds can form a film on the magnesium metal droplets preventing their coalescence. The reactions between the carbon of the commonly used anodes and reactive oxygen species result in erosion of the anodes and the formation of environmentally harmful compounds.

By providing a method of producing an electrolyte low in these impurities from crude magnesium chloride, these problems can be avoided without having to resort to complex or inefficient methods for obtaining high purity magnesium chloride.

The present technology provides for a process that avoids the complexity of the other processes in use today by taking advantage of the reaction of molten materials with MgCl₂·6H₂O or lower hydrated forms of MgCl₂ (MgCl₂ hydrate) and separating out the hydrolysis products, leaving a molten salt composition enriched in anhydrous magnesium chloride.

Thereby, the present technology provides for the environmentally friendly production of high purity electrolytes comprising magnesium chloride from crude magnesium chloride or other metals such as aluminum from their respective metal salts.

In one embodiment, MgCl₂·6H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period then settled or are otherwise separated from the melt, providing a molten salt composition enriched in anhydrous magnesium chloride.

In one embodiment, MgCl₂·5H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, MgCl₂·4H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, MgCl₂·3H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, MgCl₂·2H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, MgCl₂·H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, MgCl₂·0.5H₂O is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, a mostly hydrolyzed mixture of MgCl₂ and MgO with only residual water is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In one embodiment, a mixture of MgCl₂ hydrates is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In a preferred embodiment, an anhydrous mixture comprising magnesium chloride, magnesium hydroxychloride, and magnesium oxide is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In another preferred embodiment, an anhydrous mixture comprising magnesium chloride, magnesium hydroxychloride, and magnesium oxide is added over a first time period to a stirred bath of a molten electrolyte comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In a preferred embodiment, an anhydrous mixture comprising magnesium chloride, magnesium hydroxychloride, magnesium oxide, and at least one salt selected from the group consisting of sodium chloride, potassium chloride, calcium chloride and lithium chloride, or a combination thereof, is added over a first time period to a stirred bath of a molten salt comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In another preferred embodiment, an anhydrous mixture comprising magnesium chloride, magnesium hydroxychloride, magnesium oxide, and at least one salt selected from the group consisting of sodium chloride, potassium chloride, calcium chloride and lithium chloride, or a combination thereof, is added over a first time period to a stirred bath of a molten electrolyte comprising anhydrous MgCl₂, optionally, the bath may be stirred or agitated for an additional amount of time, optionally treated with magnesium metal, and the solids are allowed to precipitate for a second time period, then settled are otherwise separated from the melt, providing a molten salt composition enriched in anhydrous magnesium chloride.

In some embodiments, the step of contacting the getter metal with molten metal salt may be conducted at a temperature below the gettering metal's melting point. Thus, in every embodiment calling for contacting the gettering metal with the molten salt or electrolyte at or above the gettering metal's melting point, the present technology also contemplates alternatively contacting of the molten metal salt or electrolyte with the gettering metal at a temperature below the gettering metal's melting point as well. This may be desirable to suppress the hydrolysis of the metal salt hydrate to the metal salt hydroxychloride or oxide. Also, in some embodiments, the present technology contemplates conducting the addition of the crude salts or crude electrolyte mix to the molten salt or electrolyte charge at one temperature, then, if the temperature for that addition was lower than the gettering metal's melting point, raising the temperature to at or above the gettering metal's melting point before or during the gettering stage. This two-stage process is particularly useful for the use of high melting point gettering metals such as, but not limited to, iron and manganese, but can be used with any other metal as well in order to maximize the efficiency of the dehydration and dehydrochlorination stage and the gettering stage.

For example, when dealing with magnesium chloride compositions, the melting point may be above or below the melting point of magnesium metal depending on the other salts or degree of hydration present and whether eutectic mixtures form.

In a preferred embodiment the initial molten salt charge in the dehydration vessel may be kept at between 400° C. and 700° C. during the addition of the crude magnesium chloride or magnesium chloride electrolyte, and then the temperature may be raised to between 650° C. and 800° C. for the gettering reaction.

In a preferred embodiment the initial molten salt charge in the dehydration vessel may be kept at between 100° C. and 500° C. during the addition of the crude aluminum chloride or aluminum chloride electrolyte, and then the temperature may be raised to between 660° C. and 800° C. for the gettering reaction.

The present technology also provides for electrolytes comprising magnesium chloride further comprising less than about 12, 6, 4, 2, 1, 0.75, 0.5, 0.25, 0.125, 0.0625, or 0.03125 moles of waters per mole of magnesium.

The present technology also provides for electrolytes comprising magnesium chloride further comprising less than about 50, 40, 30, 20, 10, 5, 2.5, 1.25, 0.75, 0.5, 0.25, 0.125, 0.0625, or 0.03125 percent of magnesium oxide relative to the contained magnesium chloride.

The present technology also provides for electrolytes comprising calcium chloride further comprising less than about 12, 6, 4, 2, 1, 0.75, 0.5, 0.25, 0.125, 0.0625, or 0.03125 moles of waters per mole of calcium.

The present technology also provides for electrolytes comprising calcium chloride further comprising less than about 50, 40, 30, 20, 10, 5, 2.5, 1.25, 0.75, 0.5, 0.25, 0.125, 0.0625, or 0.03125 percent of calcium oxide relative to the contained calcium chloride.

The present technology also provides for electrolytes comprising aluminum chloride further comprising less than about 12, 6, 4, 2, 1, 0.75, 0.5, 0.25, 0.125, 0.0625, or 0.03125 moles of waters per mole of aluminum.

The present technology also provides for electrolytes comprising aluminum chloride further comprising less than about 50, 40, 30, 20, 10, 5, 2.5, 1.25, 0.75, 0.5, 0.25, 0.125, 0.0625, or 0.03125 percent of aluminum oxide relative to the contained aluminum chloride.

In some embodiments, the present technology provides for a use for aluminum dust that would be otherwise uneconomical to recycle or otherwise put to use.

In some embodiments, aluminum dust used as the getter metal may be produced from aluminum scrap by methods known in the art.

In some embodiments, the systems and methods disclosed herein may be used for the production of high purity electrolytes other than those comprising magnesium chloride.

In some embodiments, the electrolyte may comprise a cation or cations selected from the group consisting of Li⁺, Na⁺, K⁺, Mg²⁺, Ca²⁺, Sr²⁺, Al³⁺, Cs⁻, Rb⁺, Ba²⁺, Zn²⁺, Mn⁺, Mn²⁺, Mn³⁺, Mn⁴⁺, Mn⁵⁺, Mn⁶⁺, Mn⁷⁺, Fe²⁺, Fe³⁺, Fe⁴⁺, Fe⁶⁺, or a combination thereof in addition or instead of Mg²⁺.

In one embodiment, the purified electrolyte may comprise an anion or anions selected from the group consisting of Cl⁻, Br⁻, I⁻, F⁻, SO₄²⁻, O²⁻, HCO₃⁻, CO₃²⁻, OH⁻, or a combination thereof.

In one embodiment, the present technology provides for a system to purify magnesium chloride or electrolytes comprising magnesium chloride that are first prepared from crude magnesium chloride which is obtained from brines.

In one embodiment, the present technology provides for a system to purify calcium chloride or electrolytes comprising calcium chloride.

In one embodiment, the present technology provides for a process for purifying a molten electrolyte comprising magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte.

In another embodiment, the present technology provides for a process for purifying molten crude magnesium chloride, the process comprising: contacting the molten crude magnesium chloride with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten magnesium chloride.

In one embodiment, the present technology provides for a process for purifying a molten electrolyte comprising magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude magnesium chloride, the process comprising: contacting the molten crude magnesium chloride with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten magnesium chloride; wherein the molten getter metal is maintained in the form of a globular suspension during at least one part of the purification process.

In one embodiment, the present technology provides for a process for purifying a molten electrolyte comprising magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for magnesium production.

In another embodiment, the present technology provides for a process for purifying molten crude magnesium chloride, the process comprising: contacting the molten crude magnesium chloride with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place outside of an electrolytic cell used for magnesium production.

In one embodiment, the present technology provides for a process for purifying a molten electrolyte comprising magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within an electrolytic cell used for magnesium production.

In one embodiment, the present technology provides for a process for purifying a molten magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place within of an electrolytic cell used for magnesium production.

In one embodiment, the present technology provides for a process for purifying a molten electrolyte comprising magnesium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte.

In another embodiment, the present technology provides for a process for purifying molten crude magnesium chloride, the process comprising: contacting the molten crude magnesium chloride with a getter metal selected from the group consisting of magnesium, calcium, aluminum, zinc, tin, copper, manganese, potassium, iron, and sodium at a temperature at or above the getter metal's melting point; removing the insoluble materials; thereby, obtaining purified molten magnesium chloride.

In one embodiment, the present technology provides for a process for purifying a molten electrolyte comprising magnesium chloride, the process comprising: contacting the molten electrolyte with a getter metal selected from the group consisting of magnesium, calcium, aluminum, zinc, tin, copper, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude magnesium chloride, the process comprising: contacting the molten crude magnesium chloride with a getter metal selected from the group consisting of magnesium, calcium, aluminum, zinc, tin, copper, manganese, potassium, iron, and sodium at a temperature at or above the getter metal's melting point; removing the insoluble materials; thereby, obtaining purified molten magnesium chloride; wherein the molten getter metal is maintained in the form of a globular suspension during at least one part of the purification process.

In one embodiment, the present technology provides for a process for purifying a molten electrolyte comprising magnesium chloride, the process comprising: contacting the molten electrolyte with a getter metal selected from the group consisting of magnesium, calcium, aluminum, zinc, tin, copper, manganese, potassium, iron, and sodium at a temperature at or above the getter metal's melting point, removing the insoluble materials; thereby obtaining purified molten electrolyte; wherein the molten getter metal is maintained in the form of a globular suspension during at least one part of the purification process and the purification reaction takes place outside of an electrolytic cell used for magnesium production.

In another embodiment, the present technology provides for a process for purifying molten crude magnesium chloride, the process comprising: contacting the molten crude magnesium chloride with a getter metal selected from the group consisting of magnesium, calcium, aluminum, zinc, tin, copper, manganese, potassium, iron, and sodium at a temperature at or above the getter metal's melting point; and removing the insoluble materials, thereby obtaining purified molten magnesium chloride; wherein the molten getter metal is maintained in the form of a globular suspension during at least one part of the purification process and the purification reaction takes place outside of an electrolytic cell used for magnesium production.

In one embodiment, the present technology provides for a process for purifying a molten electrolyte comprising magnesium chloride, the process comprising: contacting the molten electrolyte with a getter metal selected from the group consisting of magnesium, calcium, aluminum, zinc, tin, copper, manganese, potassium, iron, and sodium at a temperature at or above the getter metal's melting point;

removing the insoluble materials; thereby, obtaining purified molten electrolyte; wherein the molten getter metal is maintained in the form of a globular suspension during at least one part of the purification process and the purification reaction takes place within of an electrolytic cell used for magnesium production.

In one embodiment, the present technology provides for a process for purifying a molten electrolyte comprising magnesium chloride, the process comprising: contacting the molten electrolyte with a getter metal selected from the group consisting of magnesium, calcium, aluminum, zinc, tin, copper, manganese, potassium, iron, and sodium at a temperature at or above the getter metal's melting point; removing the insoluble materials; thereby obtaining purified molten magnesium chloride; wherein the molten getter metal is maintained in the form of a globular suspension during at least one part of the purification process and the purification reaction takes place within of an electrolytic cell used for magnesium production.

In one embodiment, the present technology provides for a process for purifying a molten electrolyte comprising magnesium chloride, the process comprising: contacting the molten electrolyte with a calcium or calcium alloy getter metal at a temperature at or above the getter metal's melting point; removing the insoluble materials; thereby, obtaining purified molten electrolyte.

In another embodiment, the present technology provides for a process for purifying molten crude magnesium chloride, the process comprising: contacting the molten electrolyte with a calcium or calcium alloy getter metal at a temperature at or above the getter metal's melting point; removing the insoluble materials; thereby, obtaining purified molten magnesium chloride.

In one embodiment, the present technology provides for a process for purifying a molten electrolyte comprising magnesium chloride, the process comprising: contacting the molten electrolyte with a calcium or calcium alloy getter metal at a temperature; above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude magnesium chloride, the process comprising: contacting the molten electrolyte with a calcium or calcium alloy getter metal at a temperature at or above the getter metal's melting point; removing the insoluble materials; thereby, obtaining purified molten magnesium chloride; wherein the molten getter metal is maintained in the form of a globular suspension during at least one part of the purification process.

In one embodiment, the present technology provides for a process for purifying a molten electrolyte comprising magnesium chloride, the process comprising: contacting the molten electrolyte with a calcium or calcium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for magnesium production.

In another embodiment, the present technology provides for a process for purifying molten crude magnesium chloride, the process comprising: contacting the molten electrolyte with a calcium or calcium alloy getter metal at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place outside of an electrolytic cell used for magnesium production.

In one embodiment, the present technology provides for a process for purifying a molten electrolyte comprising magnesium chloride, the process comprising: contacting the molten electrolyte with a calcium or calcium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for magnesium production.

In one embodiment, the present technology provides for a process for purifying molten crude magnesium chloride, the process comprising: contacting the molten electrolyte with a calcium or calcium alloy getter metal at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place within of an electrolytic cell used for magnesium production.

In one embodiment, the present technology provides for a process for purifying a molten electrolyte comprising magnesium chloride, the process comprising: contacting the molten electrolyte with a magnesium or magnesium alloy getter metal at a temperature at or above the getter metal's melting point; removing the insoluble materials; thereby, obtaining purified molten electrolyte.

In another embodiment, the present technology provides for a process for purifying molten crude magnesium chloride, the process comprising contacting the molten electrolyte with a magnesium or magnesium alloy getter metal at a temperature at or above the getter metal's melting point; removing the insoluble materials; thereby, obtaining purified molten magnesium chloride.

In one embodiment, the present technology provides for a process for purifying a molten electrolyte comprising magnesium chloride, the process comprising: contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude magnesium chloride, the process comprising: contacting the molten electrolyte with a magnesium or magnesium alloy getter metal at a temperature at or above the getter metal's melting point; removing the insoluble materials; thereby, obtaining purified molten magnesium chloride;

wherein the molten getter metal is maintained in the form of a globular suspension during at least one part of the purification process.

In one embodiment, the present technology provides for a process for purifying a molten electrolyte comprising magnesium chloride, the process comprising contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for magnesium production.

In another embodiment, the present technology provides for a process for purifying molten crude magnesium chloride, the process comprising: contacting the molten electrolyte with a magnesium or magnesium alloy getter metal at a temperature at or above the getter metal's melting point; removing the insoluble materials; thereby, obtaining purified molten magnesium chloride;

wherein the molten getter metal is maintained in the form of a globular suspension during at least one part of the purification process and the purification reaction takes place outside of an electrolytic cell used for magnesium production.

In one embodiment, the present technology provides for a process for purifying a molten electrolyte comprising magnesium chloride, the process comprising: contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for magnesium production and the getter metal has not been initially produced by the electrolytic cell.

In one embodiment, the present technology provides for a process for purifying a molten electrolyte comprising magnesium chloride, the process comprising: contacting the molten electrolyte with a magnesium or magnesium alloy getter metal at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place within of an electrolytic cell used for magnesium production and the getter metal has not been initially produced by the electrolytic cell.

In one embodiment, the present technology provides for a process for purifying a molten electrolyte comprising magnesium chloride, the process comprising: contacting the molten electrolyte with a aluminum or aluminum alloy getter metal at a temperature at or above the getter metal's melting point; removing the insoluble materials; thereby, obtaining purified molten electrolyte.

In another embodiment, the present technology provides for a process for purifying molten crude magnesium chloride, the process comprising contacting the molten electrolyte with an aluminum or aluminum alloy getter metal at a temperature at or above the getter metal's melting point; removing the insoluble materials; thereby, obtaining purified molten magnesium chloride.

In one embodiment, the present technology provides for a process for purifying a molten electrolyte comprising magnesium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude magnesium chloride, the process comprising: contacting the molten electrolyte with an aluminum or aluminum alloy getter metal at a temperature at or above the getter metal's melting point; removing the insoluble materials; thereby, obtaining purified molten magnesium chloride; wherein the molten getter metal is maintained in the form of a globular suspension during at least one part of the purification process.

In one embodiment, the present technology provides for a process for purifying a molten electrolyte comprising magnesium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for magnesium production.

In another embodiment, the present technology provides for a process for purifying molten crude magnesium chloride, the process comprising: contacting the molten electrolyte with an aluminum or aluminum alloy getter metal at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place outside of an electrolytic cell used for magnesium production.

In one embodiment, the present technology provides for a process for purifying a molten electrolyte comprising magnesium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for magnesium production.

In one embodiment, the present technology provides for a process for purifying molten crude magnesium chloride, the process comprising: contacting the molten electrolyte with an aluminum or aluminum alloy getter metal at a temperature at or above the getter metal's melting point; removing the insoluble materials; thereby, obtaining purified molten magnesium chloride; wherein the molten getter metal is maintained in the form of a globular suspension during at least one part of the purification process and the purification reaction takes place within of an electrolytic cell used for magnesium production.

In some embodiments, when the purification reaction is conducted in an electrolytic cell used for magnesium or production, the getter metal is added before the electrolytic process is initiated.

In one embodiment, the present technology provides for a process for purifying a molten electrolyte comprising calcium chloride, the process comprising: contacting the molten electrolyte with a getter metal selected from the group consisting of magnesium, calcium, aluminum, zinc, tin, copper, magnesium, manganese, potassium, iron, and sodium at a temperature at or above the getter metal's melting point; removing the insoluble materials; thereby, obtaining purified molten electrolyte.

In another embodiment, the present technology provides for a process for purifying molten crude calcium chloride, the process comprising: contacting the molten crude calcium chloride with a getter metal selected from the group consisting of magnesium, calcium, aluminum, zinc, tin, copper, magnesium, manganese, potassium, iron, and sodium at a temperature at or above the getter metal's melting point; removing the insoluble materials; thereby, obtaining purified molten calcium chloride.

In one embodiment, the present technology provides for a process for purifying a molten electrolyte comprising calcium chloride, the process comprising: contacting the molten electrolyte with a getter metal selected from the group consisting of magnesium, calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude calcium chloride, the process comprising: contacting the molten crude calcium chloride with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten calcium chloride; wherein the molten getter metal is maintained in the form of a globular suspension during at least one part of the purification process.

In one embodiment, the present technology provides for a process for purifying a molten electrolyte comprising calcium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for calcium production.

In another embodiment, the present technology provides for a process for purifying molten crude calcium chloride, the process comprising: contacting the molten crude calcium chloride with a getter metal selected from the group consisting of calcium, aluminum, zinc, tin, copper, magnesium, manganese, potassium, iron, and sodium at a temperature at or above the getter metal's melting pointpoint; removing the insoluble materials; thereby, obtaining purified molten calcium chloride; wherein the molten getter metal is maintained in the form of a globular suspension during at least one part of the purification process and the purification reaction takes place outside of an electrolytic cell used for calcium production.

In one embodiment, the present technology provides for a process for purifying a molten electrolyte comprising calcium chloride, the process comprising: contacting the molten electrolyte with a getter metal selected from the group consisting of calcium, aluminum, zinc, tin, copper, magnesium, manganese, potassium, iron, and sodium at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for calcium production.

In one embodiment, the present technology provides for a process for purifying a molten electrolyte comprising calcium chloride, the process comprising: contacting the molten electrolyte with a getter metal selected from the group consisting of calcium, aluminum, zinc, tin, copper, magnesium manganese, potassium, iron, and sodium at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place within of an electrolytic cell used for calcium production.

In one embodiment, the present technology provides for a process for purifying a molten electrolyte comprising calcium chloride, the process comprising: contacting the molten electrolyte with a calcium or calcium alloy getter metal at a temperature at or above the getter metal's melting point; removing the insoluble materials; thereby, obtaining purified molten electrolyte.

In another embodiment, the present technology provides for a process for purifying molten crude calcium chloride, the process comprising: contacting the molten electrolyte with a calcium or calcium alloy getter metal at a temperature at or above the getter metal's melting point; removing the insoluble materials; thereby, obtaining purified molten calcium chloride.

In one embodiment, the present technology provides for a process for purifying a molten electrolyte comprising calcium chloride, the process comprising: contacting the molten electrolyte with a calcium or calcium alloy getter metal at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude calcium chloride, the process comprising: contacting the molten electrolyte with a calcium or calcium alloy getter metal at a temperature at or above the getter metal's melting point; removing the insoluble materials; thereby, obtaining purified molten calcium chloride; wherein the molten getter metal is maintained in the form of a globular suspension during at least one part of the purification process.

In one embodiment, the present technology provides for a process for purifying a molten electrolyte comprising calcium chloride, the process comprising: contacting the molten electrolyte with a calcium or calcium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for calcium production.

In another embodiment, the present technology provides for a process for purifying molten crude calcium chloride, the process comprising: contacting the molten electrolyte with a calcium or calcium alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place outside of an electrolytic cell used for calcium production.

In one embodiment, the present technology provides for a process for purifying a molten electrolyte comprising calcium chloride, the process comprising: contacting the molten electrolyte with a calcium or calcium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for calcium production.

In one embodiment, the present technology provides for a process for purifying molten crude calcium chloride, the process comprising: contacting the molten electrolyte with a calcium or calcium alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place within of an electrolytic cell used for calcium production.

In one embodiment, the present technology provides for a process for purifying a molten electrolyte comprising calcium chloride, the process comprising: contacting the molten electrolyte with a magnesium or magnesium alloy getter metal at a temperature at or above the getter metal's melting point; removing the insoluble materials; thereby, obtaining purified molten electrolyte.

In another embodiment, the present technology provides for a process for purifying molten crude calcium chloride, the process comprising: contacting the molten electrolyte with a magnesium or magnesium alloy getter metal at a temperature at or above the getter metal's melting point; removing the insoluble materials; thereby, obtaining purified molten calcium chloride.

In one embodiment, the present technology provides for a process for purifying a molten electrolyte comprising calcium chloride, the process comprising: contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude calcium chloride, the process comprising: contacting the molten electrolyte with a magnesium or magnesium alloy getter metal at a temperature at or above the getter metal's melting point; removing the insoluble materials; thereby, obtaining purified molten calcium chloride; wherein the molten getter metal is maintained in the form of a globular suspension during at least one part of the purification process.

In one embodiment, the present technology provides for a process for purifying a molten electrolyte comprising calcium chloride, the process comprising: contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for calcium production.

In another embodiment, the present technology provides for a process for purifying molten crude calcium chloride, the process comprising: contacting the molten electrolyte with a magnesium or magnesium alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place outside of an electrolytic cell used for calcium production.

In one embodiment, the present technology provides for a process for purifying a molten electrolyte comprising calcium chloride, the process comprising: contacting the molten electrolyte with a magnesium or magnesium alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell and the getter metal has not been initially produced by the electrolytic cell.

In one embodiment, the present technology provides for a process for purifying a molten electrolyte comprising calcium chloride, the process comprising: contacting the molten electrolyte with a magnesium or magnesium alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place within of an electrolytic cell and the getter metal has not been initially produced by the electrolytic cell.

In one embodiment, the present technology provides for a process for purifying a molten electrolyte comprising calcium chloride, the process comprising: contacting the molten electrolyte with a aluminum or aluminum alloy getter metal at a temperature at or above the getter metal's melting point; removing the insoluble materials; thereby, obtaining purified molten electrolyte.

In another embodiment, the present technology provides for a process for purifying molten crude calcium chloride, the process comprising: contacting the molten electrolyte with an aluminum or aluminum alloy getter metal at a temperature at or above the getter metal's melting point; removing the insoluble materials; thereby, obtaining purified molten calcium chloride.

In one embodiment, the present technology provides for a process for purifying a molten electrolyte comprising calcium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process.

In another embodiment, the present technology provides for a process for purifying molten crude calcium chloride, the process comprising: contacting the molten electrolyte with an aluminum or aluminum alloy getter metal at a temperature at or above the getter metal's melting point; removing the insoluble materials; thereby, obtaining purified molten calcium chloride; wherein the molten getter metal is maintained in the form of a globular suspension during at least one part of the purification process.

In one embodiment, the present technology provides for a process for purifying a molten electrolyte comprising calcium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place outside of an electrolytic cell used for calcium production.

In another embodiment, the present technology provides for a process for purifying molten crude calcium chloride, the process comprising: contacting the molten electrolyte with an aluminum or aluminum alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place outside of an electrolytic cell used for calcium production.

In one embodiment, the present technology provides for a process for purifying a molten electrolyte comprising calcium chloride, the process comprising: contacting the molten electrolyte with an aluminum or aluminum alloy getter metal at a temperature at or above the getter metal's melting point; removing the insoluble materials; thereby, obtaining purified molten electrolyte; wherein the molten getter metal is maintained in the form of a globular suspension during at least one part of the purification process and the purification reaction takes place within of an electrolytic cell used for magnesium production.

In one embodiment, the present technology provides for a process for purifying molten crude calcium chloride, the process comprising: contacting the molten electrolyte with an aluminum or aluminum alloy getter metal at a temperature at or above the getter metal's melting point; removing the insoluble materials; thereby, obtaining purified molten calcium chloride; wherein the molten getter metal is maintained in the form of a globular suspension during at least one part of the purification process and the purification reaction takes place within of an electrolytic cell used for calcium production.

In some embodiments, when the purification reaction is conducted in an electrolytic cell used for calcium production, the getter metal is added before the electrolytic process is initiated.

In other embodiments, the present technology provides for a composition comprising electrolytic grade magnesium chloride made by a process described herein.

In some other embodiments, the present technology provides for a composition comprising electrolytic grade calcium chloride made by a process described herein. In some embodiments, the molten getter metal is maintained in the form of a globular suspension. In those cases, the globular form of the molten getter metal may comprise, about 1%, 2%, 3%, 4%, 5%, 6%, 7%, 8%, 9%, 10%, 15%, 20%, 25%, 30%, 35%, 40%, 45%, 50%, 55%, 60%, 75%, 80%, 85%, 90%, 95%, 100%, or within a range between two values thereof of the total amount of the getter metal in the pre-treatment vessel or electrolytic cell.

In one embodiment, the present technology provides for a process for purifying a molten electrolyte comprising aluminum chloride, the process comprising:
(a) contacting the molten electrolyte with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten electrolyte.

In another embodiment, the present technology provides for a process for purifying molten crude aluminum chloride, the process comprising:
(a) contacting the molten crude aluminum chloride with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten aluminum chloride.

In one embodiment, the present technology provides for a process for purifying a molten electrolyte comprising aluminum chloride, the process comprising:
(a) contacting the molten electrolyte with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten electrolyte;
wherein the molten getter metal is maintained in the form of a globular suspension during at least one part of the purification process.

In another embodiment, the present technology provides for a process for purifying molten crude aluminum chloride, the process comprising:
(a) contacting the molten crude aluminum chloride with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process.

In one embodiment, the present technology provides for a process for purifying a molten electrolyte comprising aluminum chloride, the process comprising:
(a) contacting the molten electrolyte with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place outside of an electrolytic cell used for aluminum production.

In another embodiment, the present technology provides for a process for purifying molten crude aluminum chloride, the process comprising:
(a) contacting the molten crude aluminum chloride with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place outside of an electrolytic cell used for aluminum production.

In one embodiment, the present technology provides for a process for purifying a molten electrolyte comprising aluminum chloride, the process comprising:
(a) contacting the molten electrolyte with a getter metal selected from the group consisting of calcium, aluminum, zinc, tin, copper, magnesium, manganese, potassium, iron, and sodium at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place within of an electrolytic cell used for aluminum production.

In one embodiment, the present technology provides for a process for purifying molten crude aluminum chloride, the process comprising:
(a) contacting the molten crude aluminum chloride with a getter metal selected from the group consisting of calcium, aluminum, zinc, tin, copper, magnesium manganese, potassium, iron, and sodium at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place within of an electrolytic cell used for aluminum production.

In one embodiment, the present technology provides for a process for purifying a molten electrolyte comprising aluminum chloride, the process comprising:
(a) contacting the molten electrolyte with an aluminum or aluminum alloy getter metal at a temperature at or above the getter metal's melting point;
(b) removing the insoluble materials;
(c) thereby, obtaining purified molten electrolyte.

In another embodiment, the present technology provides for a process for purifying molten crude aluminum chloride, the process comprising:
(a) contacting the molten crude aluminum chloride with an aluminum or aluminum alloy getter metal at a temperature at or above the getter metal's melting point;
(b) removing the insoluble materials;
(c) thereby, obtaining purified molten aluminum chloride.

In one embodiment, the present technology provides for a process for purifying a molten electrolyte comprising aluminum chloride, the process comprising:
(a) contacting the molten electrolyte with an aluminum or aluminum alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process.

In another embodiment, the present technology provides for a process for purifying molten crude aluminum chloride, the process comprising:
(a) contacting the molten crude aluminum chloride with an aluminum or aluminum alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process.

In one embodiment, the present technology provides for a process for purifying a molten electrolyte comprising aluminum chloride, the process comprising:
(a) contacting the molten electrolyte with an aluminum or aluminum alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place outside of an electrolytic cell used for aluminum production.

In another embodiment, the present technology provides for a process for purifying molten crude aluminum chloride, the process comprising:
(a) contacting the molten crude aluminum chloride with an aluminum or aluminum alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place outside of an electrolytic cell used for aluminum production.

In one embodiment, the present technology provides for a process for purifying a molten electrolyte comprising aluminum chloride, the process comprising:
(a) contacting the molten electrolyte with an aluminum or aluminum alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place within of an electrolytic cell used for aluminum production.

In one embodiment, the present technology provides for a process for purifying molten crude aluminum chloride, the process comprising:
(a) contacting the molten crude aluminum chloride with an aluminum or aluminum alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place within of an electrolytic cell used for aluminum production.

In one embodiment, the present technology provides for a process for purifying a molten electrolyte comprising aluminum chloride, the process comprising:
(a) contacting the molten electrolyte with a magnesium or magnesium alloy getter metal at a temperature at or above the getter metal's melting point;
(b) removing the insoluble materials;
(c) thereby, obtaining purified molten electrolyte.

In another embodiment, the present technology provides for a process for purifying molten crude aluminum chloride, the process comprising:
(a) contacting the molten crude aluminum chloride with a magnesium or magnesium alloy getter metal at a temperature at or above the getter metal's melting point;
(b) removing the insoluble materials;
(c) thereby, obtaining purified molten aluminum chloride.

In one embodiment, the present technology provides for a process for purifying a molten electrolyte comprising aluminum chloride, the process comprising:
(a) contacting the molten electrolyte with a magnesium or magnesium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process.

In another embodiment, the present technology provides for a process for purifying molten crude aluminum chloride, the process comprising:
(a) contacting the molten crude aluminum chloride with a magnesium or magnesium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process.

In one embodiment, the present technology provides for a process for purifying a molten electrolyte comprising aluminum chloride, the process comprising:
(a) contacting the molten electrolyte with a magnesium or magnesium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place outside of an electrolytic cell used for aluminum production.

In another embodiment, the present technology provides for a process for purifying molten crude aluminum chloride, the process comprising:
(a) contacting the molten crude aluminum chloride with a magnesium or magnesium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place outside of an electrolytic cell used for aluminum production.

In one embodiment, the present technology provides for a process for purifying a molten electrolyte comprising aluminum chloride, the process comprising:
(a) contacting the molten electrolyte with a magnesium or magnesium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place within of an electrolytic cell and the getter metal has not been initially produced by the electrolytic cell.

In one embodiment, the present technology provides for a process for purifying molten crude aluminum chloride, the process comprising:
(a) contacting the molten crude aluminum chloride with a magnesium or magnesium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place within of an electrolytic cell and the getter metal has been initially produced by the electrolytic cell.

In one embodiment, the present technology provides for a process for purifying a molten electrolyte comprising aluminum chloride, the process comprising:
(a) contacting the molten electrolyte with an aluminum or aluminum alloy getter metal at a temperature at or above the getter metal's melting point;
(b) removing the insoluble materials;
(c) thereby, obtaining purified molten electrolyte.

In another embodiment, the present technology provides for a process for purifying molten crude aluminum chloride, the process comprising:
(a) contacting the molten crude aluminum chloride with a calcium or calcium alloy getter metal at a temperature at or above the getter metal's melting point;
(b) removing the insoluble materials;
(c) thereby, obtaining purified molten aluminum chloride.

In one embodiment, the present technology provides for a process for purifying a molten electrolyte comprising aluminum chloride, the process comprising:
(a) contacting the molten electrolyte with a calcium or calcium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process.

In another embodiment, the present technology provides for a process for purifying molten crude aluminum chloride, the process comprising:
(a) contacting the molten crude aluminum chloride with a calcium or calcium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process.

In one embodiment, the present technology provides for a process for purifying a molten electrolyte comprising aluminum chloride, the process comprising:
(a) contacting the molten electrolyte with a calcium or calcium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place outside of an electrolytic cell used for aluminum production.

In another embodiment, the present technology provides for a process for purifying molten crude aluminum chloride, the process comprising:
(a) contacting the molten crude aluminum chloride with a calcium or calcium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place outside of an electrolytic cell used for aluminum production.

In one embodiment, the present technology provides for a process for purifying a molten electrolyte comprising aluminum chloride, the process comprising:
(a) contacting the molten electrolyte with a calcium or calcium alloy getter metal at a temperature at or above the getter metal's melting point;
(b) removing the insoluble materials;
(c) thereby, obtaining purified molten electrolyte;
wherein the molten getter metal is maintained in the form of a globular suspension during at least one part of the purification process and the purification reaction takes place within of an electrolytic cell used for aluminum production.

In one embodiment, the present technology provides for a process for purifying molten crude aluminum chloride, the process comprising:
(a) contacting the molten crude aluminum chloride with a calcium or calcium alloy getter metal at a temperature at or above the getter metal's melting point;
(b) removing the insoluble materials;
(c) thereby, obtaining purified molten aluminum chloride;
wherein the molten getter metal is maintained in the form of a globular suspension during at least one part of the purification process and the purification reaction takes place within of an electrolytic cell used for aluminum production.

In some embodiments, when the purification reaction is conducted in an electrolytic cell used for aluminum production, the getter metal is added before the electrolytic process is initiated.

The molten salt or molten electrolyte purification process may take advantage of the thermal output of the metal production cell. In some embodiments, either the dehydration, getting or both processes are conducted in a vessel that is in thermal communication with the electrolytic cell used for the metal production. In still other embodiments, the metal production process may take place via a chemothermic method, such as, but not limited to sodiothermic reduction of magnesium chloride by elemental sodium. In the case when the metal production is performed using a chemothermic method, either the dehydration, getting or both processes are conducted in a vessel that is in thermal communication with the chemothermic cell used for the metal production.

In a preferred embodiment, the metal or metal alloy used for the gettering process is the same as the metal that is being produced by the electrolytic or chemothermic cell.

### BRIEF DESCRIPTION OF THE FIGURES

FIG. 1 illustrates a rotational action dehydration vessel for the dehydration and purification of magnesium chloride where the settling operation is performed in the vessel.

FIG. 2 illustrates two-way tipping action for the separation of decomposition products of the dehydration reaction of magnesium chloride.

FIG. 3 illustrates a separating vessel with a push-pull actuator for the separation of decomposition products of the dehydration reaction of magnesium chloride.

FIG. 4 illustrates an integrated electrolyte replenishment system.

FIG. 5 shows the electrolyte mix purification system and the electrolytic cell for the production of magnesium metal.

FIG. 6 shows the molten magnesium chloride purification system and the electrolytic cell to produce magnesium metal.

FIG. 7 shows the molten magnesium chloride purification system and the electrolytic cell to produce magnesium metal.

FIG. 8 shows the molten magnesium chloride purification system integrated into the electrolytic cell to produce magnesium metal.

FIG. 9 shows the weight % of oxygen-containing species recovered in clarified electrolyte with and without Mg gettering of the first experimental set of Example 9.

FIG. 10 shows the weight % of MgOHCl in molten electrolyte system of the second experimental set of Example 9.

FIG. 11 shows the total mass of sulfate species recovered in samples with and without Mg gettering.

FIG. 12 shows the weight % original SO₄²⁻ remaining in molten electrolyte system.

FIG. 13 shows the weight % of original SO₄²⁻ remaining in the electrolyte system, as calculated by IC and sulfate precipitation methods.

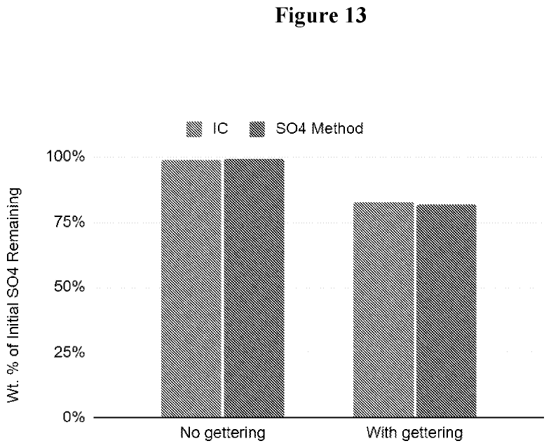

FIG. 14 shows the weight % of original SO₄²⁻ remaining in the electrolyte system, as calculated by two distinct analytical methods.

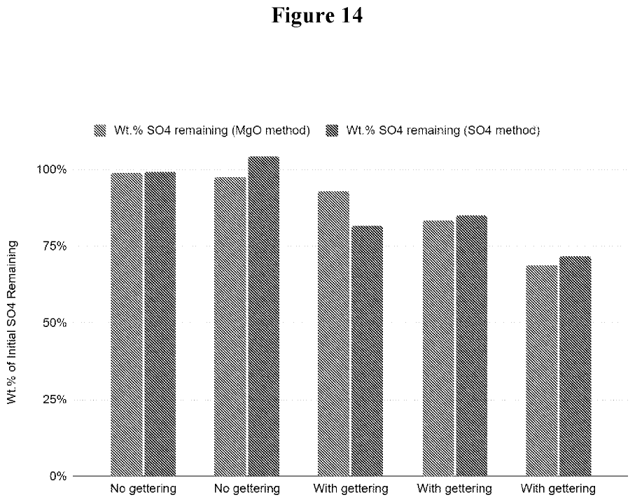

FIG. 15 shows Mass of S in the electrolyte system, as calculated by data from IC and ICP.

### DETAILED DESCRIPTION OF TECHNOLOGY

The present technology provides for a process that avoids the complexity of the other processes in use today by taking advantage of the reaction of molten materials with MgCl₂·6H₂O or lower hydrated forms of MgCl₂ and separating out the hydrolysis products, leaving a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;

b) transferring the mixture to a separating vessel;

c) holding the mixture for a second time period;

d) separating the precipitated solids from the mixture;

wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition and the first time period is from about 10 min to 60 min thereby obtaining a molten salt composition enriched in anhydrous magnesium chloride.

In an embodiment, the present technology provides for a method of dehydrating magnesium chloride hydrate bearing from about 0.01 to 1 waters of hydration comprising:
a) adding said magnesium chloride hydrate to a molten salt composition comprising anhydrous magnesium chloride over a first time period to obtain a mixture;

b) transferring the mixture to a separating vessel;

c) holding the mixture for a second time period;

d) separating the precipitated solids from the mixture;

wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min and the second time period is from about 5 min to 30 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;

b) holding the mixture for a second time period;

c) separating the precipitated solids from the mixture;

wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
thereby obtaining a molten salt composition enriched in anhydrous magnesium chloride. In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;

b) holding the mixture for a second time period;

c) separating the precipitated solids from the mixture;

wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;

b) holding the mixture for a second time period;

c) separating the precipitated solids from the mixture;

wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;

b) transferring the mixture to a separating vessel;

c) holding the mixture for a second time period;

d) separating the precipitated solids from the mixture;

wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture for a second time period;
d) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;

b) holding the mixture for a second time period;

c) separating the precipitated solids from the mixture;

wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

### Start Gettering

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;

b) holding the mixture in contact with magnesium metal for a second time period;

c) separating the precipitated solids from the mixture;

thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;

b) holding the mixture in contact with magnesium metal for a second time period;

c) separating the precipitated solids from the mixture;

wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition and the first time period is from about 10 min to 60 min thereby obtaining a molten salt composition enriched in anhydrous magnesium chloride.

In an embodiment, the present technology provides for a method of dehydrating magnesium chloride hydrate bearing from about 0.1 to 1 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;

b) holding the mixture in contact with magnesium metal for a second time period;

c) separating the precipitated solids from the mixture;

wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min and the second time period is from about 5 min to 30 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;

b) transferring the mixture to a separating vessel;

c) holding the mixture in contact with magnesium metal for a second time period;

d) separating the precipitated solids from the mixture;

wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 1 to 2 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 2 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 2.1 to 4 waters of hydration comprising:
a) adding said magnesium chloride hydrate to a molten salt composition comprising anhydrous magnesium chloride over a first time period to obtain a mixture;
b) transferring the mixture to a separating vessel;
c) holding the mixture in contact with magnesium metal for a second time period;
d) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the first time period is from about 10 min to 60 min and the second time period is from about 5 min to 240 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition and the first time period is from about 10 min to 60 min, thereby obtaining a molten salt composition enriched in anhydrous magnesium chloride.

In an embodiment, the present technology provides for a method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture in contact with magnesium metal for a second time period;
c) separating the precipitated solids from the mixture;
wherein the mass of added magnesium chloride hydrate is from about 0.001 to 0.5 times the mass of the molten salt composition, the first time period is from about 10 min to 60 min, and the second time period is from about 5 min to 240 min, thereby obtaining a molten salt composition enriched in anhydrous magnesium chloride.

In an embodiment, the present technology provides for an apparatus for the replenishing the magnesium chloride content of an electrolyte in an electrowinning cell comprising:
a) a dehydrating vessel in circular fluid communication with a separating vessel;
b) the separating vessel being in circular fluid communication with an electrowinning cell;
wherein the dehydration vessel is equipped with a heating and agitation means and the separating vessel is equipped with a heating means and removal means.

While the foregoing embodiments are directed towards magnesium chloride compositions, they analogously may be directed towards the production of purified aluminum chloride and electrolytes comprising aluminum chloride. As non-limiting examples, the following embodiments describes the purification of aluminum chloride:

In one embodiment, the present technology provides for a method of dehydrating aluminum chloride hydrate bearing from about 0.01 to 6 waters of hydration comprising:
a) adding said aluminum chloride hydrate to a molten salt composition comprising anhydrous aluminum chloride over a first time period to obtain a mixture;
b) holding the mixture for a second time period; and
c) separating the precipitated solids from the mixture;
thereby obtaining a molten salt composition enriched in anhydrous aluminum chloride.

A process for purifying a molten electrolyte comprising magnesium chloride, the process comprising:
a) contacting the molten electrolyte with a getter metal selected from the group consisting of calcium, aluminum, zinc, tin, copper, magnesium, manganese, iron and sodium; and
b) removing the insoluble materials;
thereby obtaining a purified molten electrolyte.

It is understood that other variations, including, but not limited to the ones relating to those presented for magnesium chloride purification may be applied to the purification of aluminum chloride

In another embodiment, the present technology provides for an apparatus described in example 1. In another embodiment, the present technology provides for an apparatus described in example 2. In still another embodiment, the present technology provides for an apparatus described in example 3. In another embodiment, the present technology provides for an apparatus described in example 4. In another embodiment, the present technology provides for a method of operating the apparatus described in example 1. In another embodiment, the present technology provides for a method of operating the apparatus described in example 2. In still another embodiment, the present technology provides for a method of operating the apparatus described in example 3. In another embodiment, the present technology provides for a method of operating the apparatus described in example 4.

In one embodiment, MgCl₂·hydrate is added over a first time period to a stirred bath of a molten salt comprising MgCl₂, optionally, the bath may be stirred or agitated for an additional amount of time, and the solids are allowed to precipitate for a second time period, then settled are otherwise separated from the melt, providing a molten salt composition enriched in anhydrous magnesium chloride.

In one aspect, in first time period, about 30 g of MgCl₂·2H₂O added to the bath initially containing about 180 g of molten salt over a time of about 40 min.

In one aspect, the ratio of the total added MgCl₂·2H₂O to initial load of molten salt is about 1:6.

In another aspect, the ratio of the total added MgCl₂ hydrate to initial molten salt or molten electrolyte is about 10:1, 9:1, 8:1, 7:1, 6:1, 5:1, 4:1, 3:1, 2:1, 1.5:1, 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added MgCl₂ hydrate to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In another aspect, the ratio of the total added MgCl₂·2H₂O to initial molten salt or molten electrolyte is about 10:1, 9:1, 8:1, 7:1, 6:1, 5:1, 4:1, 3:1, 2:1, 1.5:1, 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added MgCl₂·2H₂O to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In another aspect, the ratio of the total added MgCl₂·4H₂O to initial molten salt or molten electrolyte is about 10:1, 9:1, 8:1, 7:1, 6:1, 5:1, 4:1, 3:1, 2:1, 1.5:1, 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added MgCl₂·4H₂O to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In another aspect, the ratio of the total added MgCl₂·6H₂O to initial molten salt or molten electrolyte is about 10:1, 9:1, 8:1, 7:1, 6:1, 5:1, 4:1, 3:1, 2:1, 1.5:1, 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added MgCl₂·6H₂O to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In another aspect, the ratio of the total added AlCl₃ hydrate to initial molten salt or molten electrolyte is about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added AlCl₃ hydrate to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In another aspect, the ratio of the total added anhydrous composition comprising magnesium chloride, magnesium hydroxychloride and magnesium oxide to initial molten salt or molten electrolyte is about 10:1, 9:1, 8:1, 7:1, 6:1, 5:1, 4:1, 3:1, 2:1, 1.5:1, 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In another aspect, the ratio of the total added anhydrous composition comprising magnesium chloride, magnesium hydroxychloride and magnesium oxide to initial molten salt or electrolyte is about 1:32, 1:34, 1:36, 1:38, 1:40, 1:43, 1:46, 1:49, 1:52, 1:55; 1:58, 1:62, 1:64, 1:68, 1:72, 1:76, 1:80, 1:84, 1:88, 1:90, 1:91, 1:92, 1:93, 1:94, 1:95, 1:96, 1:97, 1:98, 1:99, 1:100, 1:101, 1:102, 1:103, 1:104, or 1:105.

In a preferred embodiment, the ratio of the total added magnesium chloride hydrate, anhydrous composition comprising magnesium chloride, magnesium hydroxychloride and magnesium oxide, or AlCl₃ hydrate to initial molten salt or electrolyte is from about 1:40 to 1:60.

In another aspect, the addition is done portion wise or continuously. In still another aspect, the addition is done over a first time period of about 5 min, 10 min, 15 min, 20 min, 25 min, 30 min, 35 min, 40 min, 45 min, 50 min, 55 min, 60 min, 75 min, 90 min, 105 min, 120 min, 135 min, 150 min, 165 min, 180 min, 240 min, 300 min, 360 min, 420 min, or 480 min. In a preferred embodiment, the addition is performed over between a first time period of about 0.01 min to 1 min, 1 min to 5 min, 5 min to 10 min, 10 min to 15 min, 15 min to 20 min, 20 min to 25 min, 25 min to 30 min, 35 min to 40 min, 40 min to 45 min, 45 min to 50 min, 50 min to 55 min, or 55 min to 60 min. In a preferred embodiment, second time period is about 5 min to 240 min. In a preferred embodiment, second time period is about 0.25 min to 1 min, 1 min to 5 min, 5 min to 10 min, 10 min to 20 min, 20 min to 40 min, 40 min to 120 min, 120 min to 240 min, 240 min to 360 min or 360 min to 720 min. In a preferred embodiment, the first time period is about 10 min to 60 min and the second time period is about 5 min to 240 min.

In one aspect, optionally, the bath may be stirred or agitated for about an additional 1, 2, 3, 4, 5, 6, 7, 8, 9, 10, 11, 12, 13, 14, 15, 16, 17, 18, 19, 20, 25, 30, 35, 40, 45, 50, 55, or 60 minutes after the addition performed during the first time period is complete. In one embodiment, after the stirring or agitation is complete, the hydrolysis products are allowed to settle for 1, 2, 3, 4, 5, 6, 7, 8, 9, 10, 11, 12, 13, 14, 15, 16, 17, 18, 19, 20, 21, 22, 23, or 24 h during the second time period.

In a preferred embodiment, the first time period is between about 10 min and 240 min. In a preferred embodiment, the second time period is between 5 min and 40 min. In a preferred embodiment, the first time period is between 10 min and 240 min and the second time period is between 5 min and 40 min. In a preferred embodiment, the first time period is between about 10 min and 60 min. In a preferred embodiment, the second time period is between 5 min and 40 min.

In a preferred embodiment, the first time period is between 10 min and 60 min and the second time period is between 5 min and 40 min.

In one embodiment, the bath is contained in a cylindrical dehydration vessel with an aspect ratio of height to width of between about 10:1 and 1:10. In a preferred embodiment, the aspect ratio of the cylindrical dehydration vessel is less than about 1:5.

In one aspect, after the addition of the MgCl₂·2H₂O is complete, the molten salt may be transferred to another vessel to complete the stirring and separation process. In still another aspect, after the addition of MgCl₂·2H₂O, the additional stirring procedure and the settling may be performed in separate vessels.

In another embodiment, magnesium metal may be added during the additional stirring or settling procedure. The magnesium metal may be optionally heated by inductive heating in either procedure. In one embodiment, the molten salt comprising MgCl₂ is substantially pure MgCl₂. In another embodiment, the molten salt comprising MgCl₂ comprises from about 10% to 100% MgCl₂. In still another embodiment, the molten salt comprising MgCl₂ further comprises a salt selected from the group consisting of NaCl, KCl, LiCl, CaCl₂), BaCl₂, NaF, CaF₂, and combinations thereof. In one embodiment, the molten salt comprising MgCl₂ further comprises up to about 5% BaCl₂. In one embodiment, the molten salt comprising MgCl₂ further comprises up to about 5% NaF. In one embodiment, the molten salt comprising MgCl₂ further comprises up to about 5% CaF₂. In another embodiment, the molten salt comprising MgCl₂ further comprises up to about 5% of a NaF—CaF₂ mixture. In one embodiment, the molten salt comprising MgCl₂ comprises about 10% to 100% MgCl₂. In a preferred embodiment, the molten salt comprising MgCl₂ comprises about 25% to 50% MgCl₂. In a preferred embodiment, the molten salt comprising MgCl₂ comprises about 50% to 75% NaCl.

In another preferred embodiment, the molten salt comprising MgCl₂ comprises about 50% to 75% NaCl. In another preferred embodiment, the molten salt comprising MgCl₂ comprises about 50% to 75% KCl. In another preferred embodiment, the molten salt comprising MgCl₂ comprises about 50% to 75% CaCl₂).

In one embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ comprises from about 10% to 100% MgCl₂. In one embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ comprises from about 25% to 50% MgCl₂. In another embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises a salt selected from the group consisting of NaCl, KCl, LiCl, CaCl₂), BaCl₂, NaF, KF, CaF₂, and combinations thereof. In still another embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises up to about 5% wt BaCl₂. In still another embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises up to about 5% wt NaF. In still another embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises up to about 5% wt CaF₂. In still another embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises up to about 5% wt of a NaF—CaF₂ mixture. In a preferred embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises about 50%-75% wt NaCl. In a preferred embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises about 50%-75% wt KCl. In a preferred embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises about 50%-75% wt CaCl₂). In a preferred embodiment, the present technology provides for a composition resulting from the addition of MgCl₂ hydrate to molten salt comprising anhydrous MgCl₂ in a ratio of about 1:1, 1:1.5, 1:2, 1:2.5, 1:3, 1:3.5, 1:4, 1:4.5, 1:5, 1:6; 1:7, 1:8, 1:9, 1:10, 1:11, 1:12, 1:13, 1:14, 1:15, 1:16, 1:17, 1:18, 1:19, or 1:20, where the molten salt comprising anhydrous MgCl₂ further comprises potassium chloride, sodium chloride and calcium chloride.

In a preferred embodiment, the present technology provides for a composition resulting from the addition of MgCl₂ hydrate to molten salt comprising anhydrous MgCl₂ that comprises less than 0.125% of MgO equivalents.

In another preferred embodiment, the crude magnesium chloride added to the molten salt during the dehydration or gettering process comprises about 15% to 25% magnesium calcium fluoride, barium chloride, lithium fluoride, lithium fluoride, barium fluoride, and combinations thereof.

In another preferred embodiment, the crude magnesium chloride added to the molten salt during the dehydration or gettering process comprises magnesium chloride, magnesium hydroxychloride, and magnesium oxide.

In another preferred embodiment, the crude magnesium chloride added to the molten electrolyte during the dehydration or gettering process comprises magnesium chloride, magnesium hydroxychloride, and magnesium oxide.

In another preferred embodiment, the crude magnesium chloride added to the molten salt during the dehydration or gettering process comprises about 25% to 35% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 35% to 45% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 45% to 55% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 55% to 65% magnesium calcium fluoride, barium chloride, lithium fluoride, lithium fluoride, barium fluoride, and combinations thereof.

In another preferred embodiment, the crude magnesium chloride added to the molten salt during the dehydration or gettering process comprises about 65% to 75% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 75% to 85% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 85% to 90% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 90% to 95% magnesium chloride, about 25% to 15% magnesium oxide with the balance comprising salts selected form the group consisting of potassium chloride, sodium chloride, calcium chloride, sodium fluoride, calcium fluoride, barium chloride, lithium fluoride, lithium fluoride, barium fluoride, and combinations thereof.

In another preferred embodiment, the crude magnesium chloride added to the molten salt during the dehydration or gettering process comprises about 95% to 100% magnesium calcium fluoride, barium chloride, lithium fluoride, lithium fluoride, barium fluoride, and combinations thereof.

In one embodiment, the molten salt comprising MgCl₂ is held at between about 500° C. and 1000° C.

In a preferred embodiment, the molten salt comprising MgCl₂ is held at between 600° C. and 750° C.

In some embodiments, dry air, nitrogen or argon is bubbled through the molten salt comprising MgCl₂ during the addition of the MgCl₂ hydrate.

In some embodiments, dry air, nitrogen or argon is bubbled through the molten salt comprising MgCl₂ during the additional stirring time.

In some embodiments, the space above the dehydration vessel or separating vessels may be a vacuum, dry air, nitrogen or argon.

In some embodiments, the space above the dehydration vessel or separating vessels may be a stream of dry air, nitrogen or argon.

In some embodiments, the molten salt comprising MgCl₂ may be directly fed from an electrolytic cell to the dehydration vessel, with the processes described herein replenished with MgCl₂, cleansed of MgO and MgOHCl, and then fed back to the electrolytic cell.

In some embodiments, the dehydration vessel and the electrolytic cell are in thermal communication. In some embodiments, the separating vessel and the electrolytic cell are in thermal communication. In some embodiments, the dehydration vessel, the separating vessel and the electrolytic cell are in thermal communication. In some embodiments, the dehydration vessel and the electrolytic cell are in fluid communication. In some embodiments, the separating vessel and the electrolytic cell are in fluid communication. In some embodiments, the dehydration vessel, the separating vessel and the electrolytic cell are in fluid communication. In some embodiments, the fluid communication may include a filter such as a metal, quartz or ceramic screen.

In some other embodiments, the dehydration vessel may be heated by resistive heating, fuel burners, inductive heating of an internal magnetic element, application of AC current through the molten contents, heat pumps, hot dry air, argon or nitrogen bubbled through the contents, or other means known in the art.

In some embodiments, the initial molten mass in the dehydration vessel to which the MgCl₂ hydrate is added is a molten metal selected from the group consisting of aluminum, magnesium, tin, selenium, zinc, or a combination thereof.

In some embodiments, the MgCl₂ hydrate may be added by gravity addition from a hopper or through a tube from such a height that the solids form a raft on the surface of the molten dehydration vessel contents.

In some embodiments, the MgCl₂ hydrate may be added by gravity addition from a hopper or through a tube from such a height that the solids plunge or fall below the surface of the molten dehydration vessel contents.

In some embodiments, the MgCl₂ hydrate may be added by an auger.

In some embodiments, the MgCl₂ hydrate may be added as a dispersion of solid in a gas stream of dry air, argon or nitrogen introduced from above towards the surface of the molten dehydration vessel contents.

In some other embodiments, the MgCl₂ hydrate may be added as a dispersion of solid in a gas stream of dry air, argon or nitrogen aimed from below molten dehydration vessel contents.

In some embodiments, the molten contents of the dehydration vessel may be agitated by an impeller, gas impingement, molten salt pumps, electromagnetic pumps, or rotation of the dehydration vessel.

In some other embodiments, a stream of the molten dehydration vessel contents may be passed through a venturi into which the MgCl₂ hydrate is pneumatically injected.

In some embodiments, the MgCl₂ hydrate is pneumatically fed through a venturi into which the molten dehydration vessel contents is injected.

In some embodiments, the flow into and from the separating vessel may be controlled by a freeze/thaw cycle around an inlet, outlet or zone.

In some other embodiments, a pump is used in the separating vessel to cause the solid sludge to be pumped towards an overflow outlet

In some other embodiments, a gas sparger in the separating vessel causes the solids to float towards an overflow outlet.

In some other embodiments, the separating vessel has a robotic bottom suction or scraping device that continuously removes settled solids from the bottom of the separating vessel.

In some embodiments, the separating vessel comprises a centrifuge to force the precipitated solids to the outer walls.

In some other embodiments, the precipitated solids may be removed by filtration through a metal, quartz or ceramic screen.

In some embodiments, anhydrous aluminum chloride and electrolytes comprising aluminum chloride may be prepared by substantially similar methods.

In one embodiment, the aluminum chloride hydrate feed for the dehydration may comprise from 0.01 to 1, 1, 2, 3, 4, 5, or 6 waters of hydration.

In another embodiment, the aluminum chloride hydrate may comprise total water of from 0.01% to 0.1%, 0.1% to 1%, 1% to 2%, 2% to 5%, 5% to 10% or 10% to 25% by weight.

In another embodiment, the aluminum chloride hydrate feed for the dehydration may comprise from 0.01 to 6 waters of hydration.

In one embodiment, the molten salt comprising AlCl₃ is held at between about 100° C. and 800° C.

In a preferred embodiment, the molten salt comprising AlCl₃ is held at between 100° C. and 400° C.

In another preferred embodiment, the molten salt comprising AlCl₃ is held at between 100° C. and 250° C.

In some embodiments, the temperature at which the molten salt is held during the first period is associated with a first temperature or temperature range and the temperature at which the molten salt is held during second time period is associated with a second temperature or temperature range. The first and second temperatures and temperature ranges may be the same, or different depending on the purity of the input feedstocks, the desired quality of the purified product, and the particular metal salt being processed.

In some other embodiments, agitation or stirring is stopped during the second time period.

The production of relatively pure magnesium chloride electrolytes for the purposes of metal electrowinning is a well-known challenge. Several impurities are present in the raw magnesium chloride source (typically a brine). Standard methods of impurity treatment rely on aqueous chemistry methods, which are well established in the fields of wastewater treatment and drinking water purification. Specifically, sulfate ions (SO₄²⁻) are present in the brines in significant quantities. Sulfates have damaging effects once introduced into a magnesium electrolytic cell as they can form sulfate, sulfide, and oxide layers of magnesium compounds on magnesium metal, preventing coalescence of metal, and thereby methods of eliminating such sulfates to very low concentrations are desired.

While much of the sulfate can be removed via hydrometallurgical processes before dehydration, there is interest in a subsequent sulfate removal step post dehydration. Calcium chloride is used to precipitate sulfate down to the solubility of gypsum (CaSO₄·2H₂O) which is around 1,000-2,000 ppm of SO₄²⁻ in the brine. Typically, barium chloride is then added to remove the sulfate down to the solubility of BaSO₄ near 1 ppm of sulfate in water however barium is toxic and expensive to dispose of, so it is of interest to obviate the need for barium in the process. There are strong anion exchange resins for sulfate removal from water, however they are typically used with much lower TDS solutions than ˜30 wt % TDS brines.

Sulfates are relatively stable at high temperatures, and thereby are not expected to decompose during dehydration. The sulfates are not perfectly soluble in molten chloride electrolytes, but their effects on electrolysis performance emerge at concentrations significantly lower than their solubility limit. Thereby, spontaneous decomposition or precipitation can not be relied on for the secondary removal of sulfate. We have identified that it is possible to eliminate sulfate species from electrolytes by reductive attack via the addition of magnesium metal. This enables the elimination of the need for barium chloride treatment or strong anion exchange resin treatment. Without wishing to be bound by theory, there are two plausible reaction pathways, given in equations (2) and (3) below:

$$3 Mg ( l ) + {Mg}^{2 +} ( l ) + {SO}_{4}^{2 -} ( l ) \to 4 MgO ( s ) + S ( g ) \qquad Equation 2$$

$$4 Mg ( l ) + {Mg}^{2 +} ( l ) + {SO}_{4}^{2 -} ( l ) \to 4 MgO ( s ) + Mg S ( g ) \qquad Equation 3$$

In such a reaction, residual sulfate species are converted either into gaseous elemental sulfur or insoluble magnesium sulfide. Evolved sulfur would be removed directly from the melt, while MgS could be removed along with the oxides, as described herein.

In a preferred embodiment, the electrolyte composition to be purified comprises between about 10% and 100% magnesium chloride, with the balance comprising chloride salts selected from the group consisting of potassium chloride, sodium chloride, calcium chloride and combinations thereof.

In one embodiment, the purified molten salt or purified molten electrolyte comprises less than about 1000 ppm, 900 ppm, 800 ppm, 700 ppm, 600 ppm, 500 ppm, 400 ppm, 300 ppm, 200 ppm, or 150 ppm of sulfate by weight.

one embodiment, the purified molten salt or purified molten electrolyte comprises less than about 125 ppm, 100 ppm, 90 ppm, 80 ppm, 70 ppm, 60 ppm, 50 ppm, 40 ppm, 30 ppm, 20 ppm, 10 ppm, or 5 ppm of sulfate by weight.

In a preferred embodiment, the purified molten salt or purified molten electrolyte comprises between about 25 ppm and 1000 μm of sulfate by weight.

In a preferred embodiment, the purified molten salt or purified molten electrolyte comprises between about 125 ppm and 750 μm of sulfate by weight.

In a preferred embodiment, the purified molten salt or purified molten electrolyte comprises between about 5 ppm and 750 μm of sulfate by weight.

In a preferred embodiment, the purified molten salt or purified molten electrolyte comprises between about 150 ppm and 500 μm of sulfate by weight.

In a preferred embodiment, the salt or electrolyte composition that is added to the molten salt of electrolyte in the dehydration vessel comprises at least 500 ppm sulfate by weight.

In a preferred embodiment, the electrolyte composition to be purified comprises between 0 and 6 molecules of water per atom of metal present in the electrolyte composition.

In a preferred embodiment, the molten salt composition initially charged into the dehydration vessel comprises between about 1% and 100% magnesium chloride, with the balance comprising salts selected from the group consisting of potassium chloride, sodium chloride, calcium chloride, sodium fluoride, calcium fluoride, and combinations thereof.

In a preferred embodiment, the molten salt composition initially charged into the dehydration vessel comprises less than or equal to 5 mole % of fluoride anion in relation to the total anions.

In a preferred embodiment, the molten salt composition initially charged into the dehydration vessel is raised to a temperature of between about 400 deg C. and 900 deg. C

In a preferred embodiment, the molten salt composition initially charged into the dehydration vessel comprises spent electrolyte from a magnesium electrolyzer, a mixture of components derived from mixing the individual components prior to melting, or a pre-melted composition formed in a separate crucible or furnace.

In a preferred embodiment, the dehydration vessel may be a crucible or vat, a compartment attached to an electrolyzer that is optionally in thermal communication with the said electrolyzer, a crucible mounted on pivot, a crucible mounted on a tractor vehicle, a launder of flowing molten salt, or an electrolyzer itself.

In a preferred embodiment, the oxide sludge resulting from the dehydration or gettering process is settled by gravity.

In a preferred embodiment, the oxide sludge resulting from the dehydration or gettering process are removed by a pump system and filtered out before the remaining melt is recirculated to the dehydration vessel.

In a preferred embodiment, the oxide sludge resulting from the dehydration or gettering process is removed by a decantation process.

In a preferred embodiment, the oxide sludge resulting from the dehydration or gettering process is removed by a negative or positive pressure suction system that can pull or push the molten-salt-oxide particle slurry out of the dehydration vessel.

In a preferred embodiment, when fresh oxides are formed by a gettering process post dehydration, the fresh oxides are removed by gravitational settling.

In a preferred embodiment, when fresh oxides are formed by a gettering process post dehydration, the fresh oxides are removed by a pump system and filtered out before the remaining melt is recirculated to the dehydration vessel or a gettering vessel.

In a preferred embodiment, when fresh oxides are formed by a gettering process post dehydration, the fresh oxides are removed by a decantation process.

In a preferred embodiment, when fresh oxides are formed by a gettering process post dehydration, the fresh oxides are removed by a negative or positive pressure suction system that can pull or push the molten-salt-oxide particle slurry out of the dehydration vessel or a gettering vessel.

In a preferred embodiment, the composition comprising the gettering metal is selected from the group consisting of magnesium or magnesium dross from foundry operations, aluminum or aluminum dross from foundry operations, sodium metal, calcium metal, iron, and combinations thereof.

In a preferred embodiment, the gettering metal is in ingot form about 200 mm×200 mm×1 m.

In a preferred embodiment, the gettering metal is in bead form from about 100 microns to 5 mm in diameter.

In a preferred embodiment, the gettering metal is in the molten state or semi-molten state.

In another embodiment, the gettering metal is introduced in the gas phase at a temperature above its boiling point

In a preferred embodiment, the purified molten salt composition comprises less than about 1% of oxides expressed as Mg) equivalent wt %.

While the invention has been described in connection with specific embodiments thereof, it will be understood that it is capable of further modifications and this application is intended to cover any variations, uses, or adaptations of the invention, including such departures from the present disclosure as come within known or customary practice within the art to which the invention pertains and as may be applied to the essential features hereinbefore set forth, and as follows in the scope of the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

As used herein, the singular forms “a,” “an” and “the” include plural referents unless the context clearly dictates otherwise.

As used herein, ranges are inclusive, so the range “from 4 to 6, includes 4 and 6.

As used herein, ranges and amounts can be expressed as “about” a particular value or range. As used herein the term “about” also includes the exact amount. Hence “about 5 percent” means “about 5 percent” and also “5 percent.” “About” means within typical experimental error for a measurement typically used for purpose intended, or, if referred to in the context of a process parameter, the term about should be construed in the context of the sensitivity of such process to the particular parameter. When a list of parameters or ranges is preceded by the term “about”, it is intended that the term “about” applies to each of the members of the list.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “weight percent” or “wt %” refers to the concentration of a substance as the weight of that substance divided by the total weight of the composition and multiplied by 100.

As used herein, the term “brine” refers to any aqueous solution comprising metal salts. Typically, a brine will comprise sodium, calcium, potassium or magnesium compounds, typically chlorides, bromides, iodides, hydroxides, carbonates, sulfates, bicarbonates or sulfides. Typically, the magnesium compound may be a magnesium salt, a magnesium oxide, a magnesium a magnesium hydroxide, or a magnesium hydroxy halide.

As used herein, the term “electrolytic grade MgCl₂ or MgCl₂ electrolyte salt mixture” refers to a composition comprising at least 10% magnesium chloride further comprising less than about 5 wt % of oxygenated species.

In some embodiments, the term “electrolytic grade MgCl₂ or MgCl₂ electrolyte salt mixture” refers to a composition comprising at least 10% magnesium chloride further comprising less than about 4 wt % of oxygenated species.

In some other embodiments, the term “electrolytic grade MgCl₂ or MgCl₂ electrolyte salt mixture” refers to a composition comprising at least 10% magnesium chloride further comprising less than about 3 wt % of oxygenated species.

In still other embodiments, the term “electrolytic grade MgCl₂ or MgCl₂ electrolyte salt mixture” refers to a composition comprising at least 10% magnesium chloride further comprising less than about 2 wt % of oxygenated species.

In still other embodiments, the term “electrolytic grade MgCl₂ or MgCl₂ electrolyte salt mixture” refers to a composition comprising at least 10% magnesium chloride further comprising less than about 1 wt % of oxygenated species.

In still other embodiments, the term “electrolytic grade MgCl₂ or MgCl₂ electrolyte salt mixture” refers to a composition comprising at least 10% magnesium chloride further comprising less than about 0.5 wt % of oxygenated species.

In still other embodiments, the term “electrolytic grade MgCl₂ or MgCl₂ electrolyte salt mixture” refers to a composition comprising at least 10% magnesium chloride further comprising less than about 0.25 wt % of oxygenated species.

In still other embodiments, the term “electrolytic grade MgCl₂ or MgCl₂ electrolyte salt mixture” refers to a composition comprising at least 10% magnesium chloride further comprising less than about 0.125 wt % of oxygenated species.

In still other embodiments, the term “electrolytic grade magnesium chloride”, refers to composition comprising at least 95% magnesium chloride further comprising less than about 1, 0.75, 0.5, 0.25, 0.125, 0.0625, or 0.03125 waters of hydration and MgO of less than 5 wt %.

The purified molten electrolytes produced by the processes described herein comprise electrolytic grade magnesium chloride. And the purified molten magnesium chloride is electrolytic grade magnesium chloride.

In still other embodiments, the term “electrolytic grade calcium chloride”, refers to composition comprising at least 95% calcium chloride further comprising less than about 1, 0.75, 0.5, 0.25, 0.125, 0.0625, or 0.03125 waters of hydration and CaO of less than 5 wt %.

The purified molten electrolytes produced by the processes described herein comprise electrolytic grade calcium chloride. And the purified molten calcium chloride is electrolytic grade calcium chloride.

The term “crude magnesium chloride” refers to magnesium chloride of less than 95% purity. Typically, the impurities in the magnesium chloride compositions contemplated for use herein will comprise one or more of magnesium hydroxide, magnesium oxide, magnesium hydroxychloride, sulfates, and water.

Depending on the intended use, the upper limit of the oxygenated species content may vary, but the methods described herein may be optimized to achieve those levels for the molten salt composition enriched in magnesium chloride. Thereby, when the molten salt composition enriched in magnesium chloride conforms to the particular electrolytic grade MgCl₂ or MgCl₂ electrolyte salt mixture desired, it can be called an “electrolytic grade MgCl₂ or MgCl₂ electrolyte salt mixture” may be further qualified by the upper limit of oxygenated species it contains.

### EXAMPLES

The following non-limiting examples further illustrate various aspects of the purification process.

### Example 1

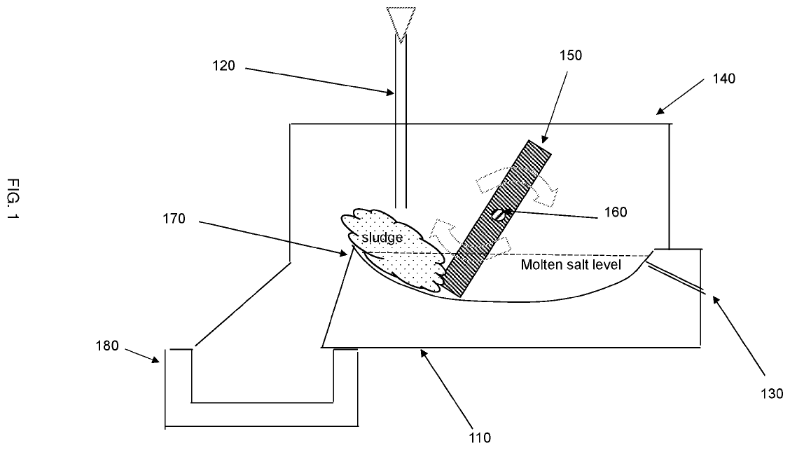

A non-limiting example of one embodiment of an integrated dehydrator and separating vessel is illustrated in FIG. 1. Here, a heated dehydration vessel 110 is equipped with an inlet 120 for the magnesium chloride hydrate, a molten salt outlet 130, a hood 140 for exhausting water vapor and HCl, a rotating screen agitator 150 held on a rotating shaft 160, a ledge 170 over which the sludge formed during the dehydration reaction is pushed, and a solids collection bin 180. During operation, the heated dehydration vessel 110 is filled with an initial molten salt composition 115. This molten salt composition may be substantially pure anhydrous magnesium chloride, or a mixture of salts comprising anhydrous magnesium chloride. Typically, this molten salt composition will be of the type usually used in the process of electrowinning magnesium and will comprise one or more of sodium chloride, potassium chloride, calcium chloride, or potassium fluoride, but may include any composition suitable for the electrowinning of magnesium. Alternatively, this apparatus may be used for the dehydration of aluminum chloride hydrate as well, where the composition of the initial molten salt charge having a composition appropriate for the electrowinning of aluminum from a molten salt composition comprising aluminum chloride. In an example where the apparatus is used for the preparation of molten anhydrous magnesium chloride or a molten salt composition comprising magnesium chloride appropriate for the electrowinning of magnesium, the operation of the apparatus is as follows: Through the inlet 120, magnesium chloride hydrate may be added in portions, or continuously at a controlled rate dependent on the operating temperature, agitation speed and exact makeup of the initial molten salt composition. In some cases, the rate of addition of the magnesium chloride hydrate and the temperature of the dehydration vessel may be varied as the makeup of the molten salt composition changes during the course of the reaction. The molten mixture may be agitated by the screen agitator, or, optionally, by another means of agitation such as an impeller, molten salt pump, or any other means suited for operation under high temperature molten salt conditions. After a desired time period where the dehydration and conversion of intermediates to MgO has taken place, agitation is stopped and after a desired settling time, the molten salt outlet may be opened, and the melt is removed from the apparatus. When a suitable amount of MgO sludge has formed, the molten salt outlet may be closed, and a portion of the sludge is pushed over the ledge by the action of the screen agitator. The process may be repeated stepwise, or at an appropriate movement rate of the screen agitator, the process may be carried out continuously as long as the residence time of the hydrate is long enough to ensure the desired degree of dehydration and the residence time of the melt is sufficient to ensure the MgO content is below the desired level. During the operation, the water and HCl vapor produced may be removed by introducing a stream dry air, nitrogen or argon over the surface of the melt and exhausting the water and HCl laden stream via an exhaust port in the hood. Alternatively, a vacuum may be created within the hood and the water and HCL may be removed via a vacuum pump.

In some embodiments, magnesium or aluminum getter metal may be introduced into the apparatus to remove boron or sulfates. The metal may be in the form of molten metal, dust, powder, flakes, wires, wool, sheets or rods. The use of getter metal is not limited to this example, but may be used with other examples shown below, or other methods, devices or systems described herein. The reactions of magnesium sulfate with magnesium yielding magnesium sulfide and magnesium oxide, which are removed in the sludge as described above. The reaction of borate with magnesium yielding hydrogen, magnesium oxide and magnesium boride which would be removed through venting in the case of hydrogen, and in the sludge in the case of magnesium oxide and magnesium boride. In some embodiments, the getter metal may be independently heated. This heating may be accomplished by resistive heating, conduction from a heat source, inductive heating or other means known in the art.

### Example 2

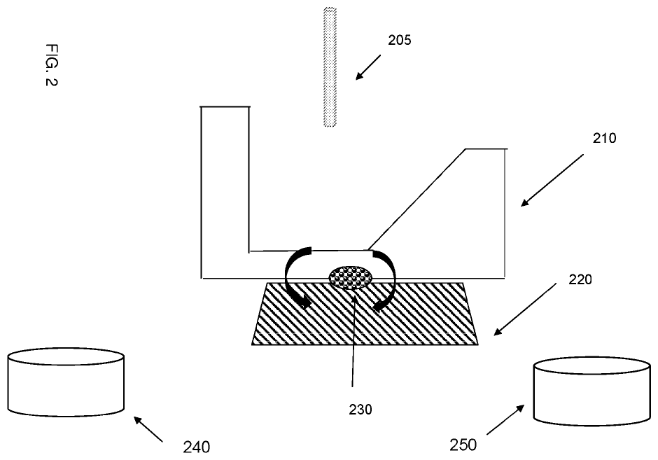

A non-limiting example of one embodiment of a separating vessel is illustrated in FIG. 2. Here, the dehydration reaction is performed in a separate dehydration vessel, and then the molten mixture is transferred to a separating vessel 210 through an inlet 205, where the dehydration reaction solid products are allowed to settle. The separating vessel has a tilting means, in this non-limiting example, a base 220 and a pivot 230. The separating vessel may, for example, have opposite walls with different slopes such that when tilted in one direction, the supernatant is preferentially ejected into the molten salt bin 240, leaving the precipitated solids at the bottom of the separating vessel, and when the vessel is tilted in the opposite direction, the sludge is deposited in the solids collection bin 250. In this example, the separating vessel may have an independent heat supply like the dehydration vessel in example 1, or, it may be in thermal communication with a electrolytic cell used for the electrowinning process, a dehydrator vessel, or both. In some cases, the separating vessel may have an independent heat supply even though it is in thermal communication with an electrolytic cell used for the electrowinning process, a dehydrator vessel, or both. In some cases, a thermal transfer system may be used to control the heat flow between the electrolytic cell, the dehydration vessel, or both.

In some embodiments, magnesium or aluminum metal may be introduced into the apparatus to remove boron or sulfates. The metal may be in the form of molten metal, dust, powder, flakes, wires, wool, sheets or rods. The reactions of magnesium sulfate with magnesium yielding magnesium sulfide and magnesium oxide, which are removed in the sludge as described above. The reaction of borate with magnesium yielding hydrogen, magnesium oxide and magnesium boride which would be removed through venting in the case of hydrogen, and in the sludge in the case of magnesium oxide and magnesium boride.

### Example 3

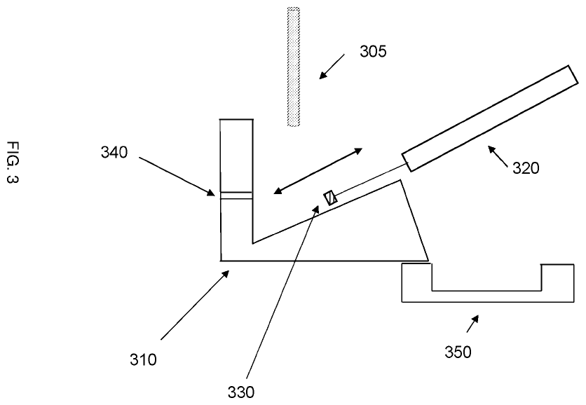

An alternative separating vessel is illustrated as a non-limiting example in FIG. 3. Here, instead of tilting as a means of separating the molten salt from the precipitated solids, the molten mixture is transferred to the separating vessel 310 through inlet 305. The separating vessel's bottom forms a ramp along which a scraper 330 is moved up and down the ramp, in this example by a hydraulic piston to pull the precipitated solids up and over the ramp to a solids collection bin 350 while the molten salt is allowed to flow out of the separating vessel through the molten salt outlet 340. Although a hydraulic piston is illustrated here, one skilled in the art can appreciate that any suitable means of driving the scraper can be used. Likewise, although a linear motion of the scraper has been illustrated here, other means of driving the precipitates over the ramp may be used, such as paddle wheels, rotary screen separators as described in example 1, or conveyor belts and the like.

### Example 4

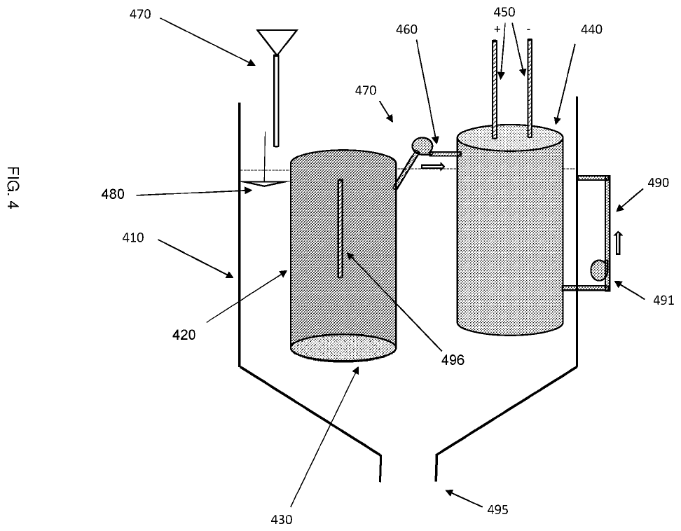

In some embodiments, the dehydration vessel and separating vessel may be incorporated into an integrated electrolyte replenishment system as illustrated in the non-limiting example shown in FIG. 4. Here, the separating vessel 420 and electrowinning cell 440 are housed within the dehydration vessel 410. The dehydrator vessel is equipped with a magnesium chloride hydrate inlet 470 on top, an agitator 480 within, and a MgO outlet at the bottom. The separating vessel has an open top and a screen bottom 430, a getter metal rod 496 and is in fluid communication via transfer pipe 460 and pump 470 with the top portion of the electrowinning cell. The electrowinning cell Is equipped with an exhausted electrolyte return pipe 490 and pump 491 leading from its bottom portion to the top portion of the dehydrator.

In operation, a molten electrolyte is introduced into the dehydrator with the level of the molten electrolyte kept just below that of the top of the separating vessel so that the molten electrolyte is forced through the filter screen bottom toward the top of the separating vessel and to the level of the electrolyte transfer pipe where it is pumped into the electrowinning cell. Once the electrolysis is ongoing, the exhausted electrolyte in the electrowinning cell, by virtue of being denser, accumulates at the bottom of the electrowinning cell and is pumped out of the electrowinning cell and into the top portion of the dehydration vessel. Contemporaneously with the exhaustion of the electrolyte by virtue of the depletion of magnesium chloride, an equivalent amount of magnesium chloride as magnesium chloride hydrate is added to the dehydration vessel via the inlet 470 such that the rate of anhydrous magnesium chloride produced in the dehydration reaction is substantially equal to the rate at which it is being consumed in the electrowinning cell. As the process proceeds, the precipitated products of the dehydration reaction that form a sludge are removed at the bottom of the dehydration vessel at outlet 495 by gravity, filtration, an augur, or other sludge removal means known in the art.

### Example 5

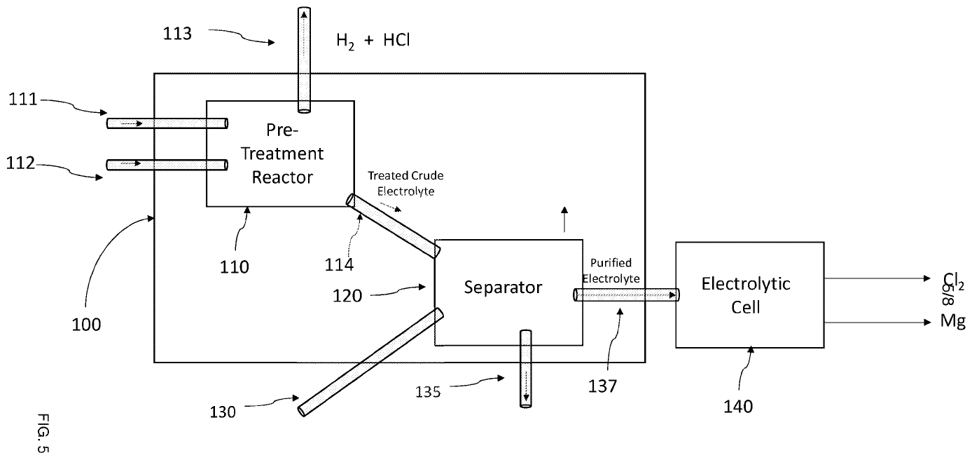

Thereby, as shown in FIG. 5, the electrolyte purification system 100 comprises of a pre-treatment vessel 110 and a separator 120. The getter metal and the crude electrolyte mix are charged into the pre-treatment vessel through inlets 111 and 112 respectively, and the mixture is heated above the getter metal's melting point. The pre-treatment vessel 110 may typically be blanketed with an inert gas such as argon. The reaction may be agitated by stirring or tumbling, or other methods known in the art. The mixture in the pre-treatment vessel is held for a period of time from 0.01 hour to 72 hours, with any hydrogen and hydrogen that is generated during the process being removed through outlet 113, hen the treated crude electrolyte is transferred to a separator 120 through transfer a transfer outlet 114, where the precipitated solids, typically the getter metal oxides are separated by centrifugation, settling, filtration, or other methods known in the art. Any of the sludge comprising precipitated getter metal oxides or other by-products may be removed via outlet 135. The treatment reaction may be conducted under conditions where some or all of the getter metal is consumed. If there is any excess getter metal, it may be removed through the outlet 130, or, if the getter metal is the same as the metal to be produced by the electrolytic cell 140, it may be simply transferred to it along with the purified molten electrolyte or molten magnesium chloride stream through the transfer outlet 137. The purified electrolyte mix is then transferred to an electrolytic cell through transfer outlet 137 to produce magnesium metal as known in the art.

### Example 6

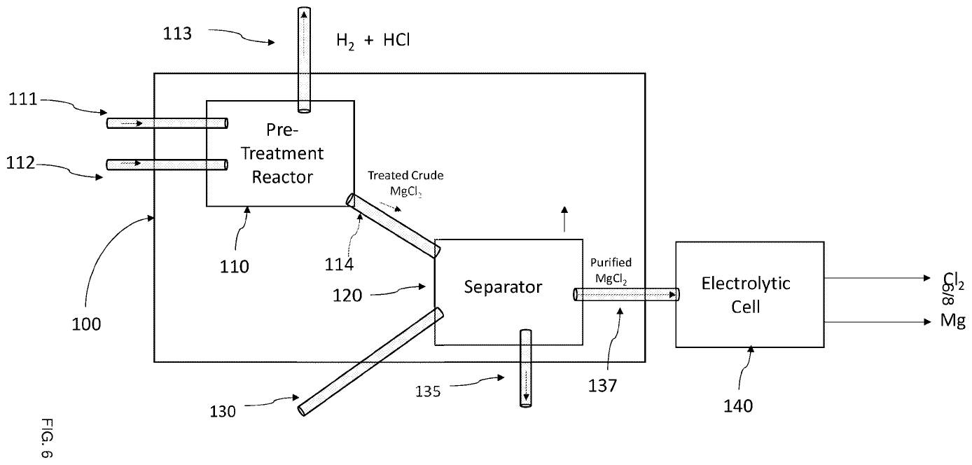

An alternative process is shown in FIG. 6, where the purification of the crude magnesium chloride is conducted before the electrolyte additives are added to make up the final purified electrolyte mix. Here, the getter metal and the crude magnesium chloride are charged into the pre-treatment vessel through inlets 111 and 112 respectively, and the mixture is heated above the getter metal's melting point. The pre-treatment vessel 110 may typically be blanketed with an inert gas such as argon. The reaction may be agitated by stirring or tumbling, or other methods known in the art. The mixture in the pre-treatment vessel is held for a period of time from 0.01 hour to 72 hours, with any hydrogen and hydrogen that is generated during the process being removed through outlet 113, then the treated crude magnesium chloride is transferred to a separator 120 through transfer a transfer outlet 114, where the precipitated solids, typically the getter metal oxides are separated by centrifugation, settling, filtration, or other methods known in the art. Any of the sludge comprising precipitated getter metal oxides or other by-products may be removed via outlet 135. The treatment reaction may be conducted under conditions where some or all of the getter metal is consumed. If there is any excess getter metal, it may be removed through the outlet 130, or, if the getter metal is the same as the metal to be produced by the electrolytic cell 140, it may be simply transferred to it along with the purified molten electrolyte or molten magnesium chloride stream through the transfer outlet 137. The purified magnesium chloride mix is then transferred to an electrolytic cell transfer outlet 137 and any additives may be added to make up a final electrolyte mix to produce magnesium metal as known in the art.

### Example 7

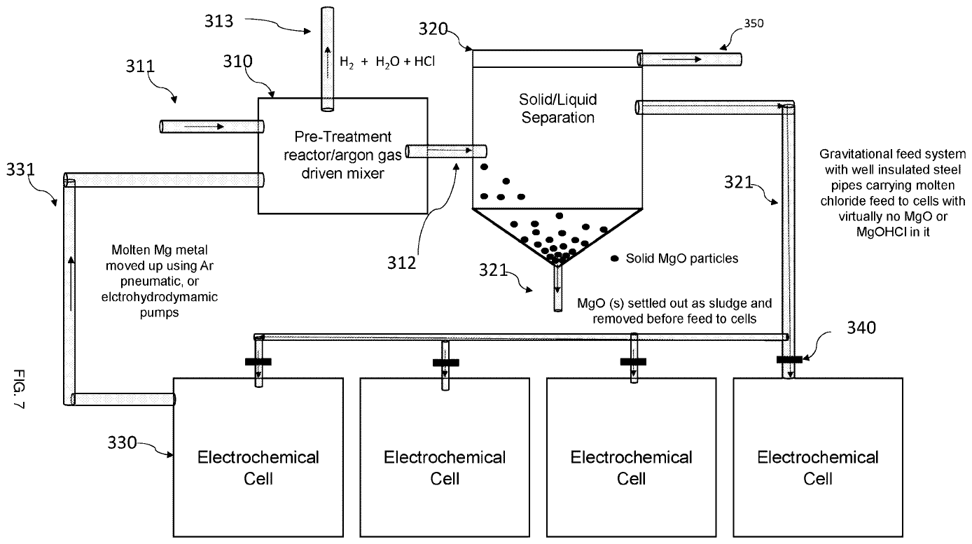

As shown in FIG. 7, a process of magnesium chloride or electrolyte purification may be integrated into the magnesium metal production process. Here, pre-treatment vessel 310 is charged with crude magnesium chloride or crude electrolyte mix through inlet 311 and any other desired additives. Once the desired temperature is achieved in the pre-treatment vessel, a charge of magnesium metal is directed from the electrolytic cell 330 through the transfer inlet 331 and the purification reaction is allowed to proceed until the desired level of purity is achieved. Any hydrogen, water and hydrogen chloride are evacuated as the process proceeds through outlet 313. The electrolytic grade magnesium chloride or electrolyte mix, along with any additional additives is directed into the separator 320 through transfer outlet 312, and then, once the impurities have been separated, into the electrolytic cell 330 via transfer outlet 321. In some cases, the initial charge of pre-treatment vessel 320 may comprise electrolytic grade magnesium chloride and any desired additives such the flow of electrolyte to the electrolytic cell may begin immediately. In some cases, the additives may be added directly to the electrolytic cell 330 so that only crude or electrolytic grade magnesium chloride is added to the pre-treatment vessel 310. The purification reaction may be conducted under conditions where some or all of the getter metal is consumed. If there is any excess getter metal, it may be removed through the outlet 350, or, if the getter metal is the same as the metal to be produced by the electrolytic cell, it may be simply transferred to it along with the purified molten electrolyte or molten magnesium chloride stream. The flow of purified molten electrolyte or molten magnesium chloride may be controlled by the flow control 340, where a jacketed pipe can be cooled or heated to freeze or melt the stream contained therein. If it is desired to slow or stop the flow of the stream, a coolant is applied to the jacket to freeze the stream, and when it is desired to start or increase the flow, the coolant is heated to above the melting point of the material in the inner pipe to melt it and facilitate its flow.

### Example 8

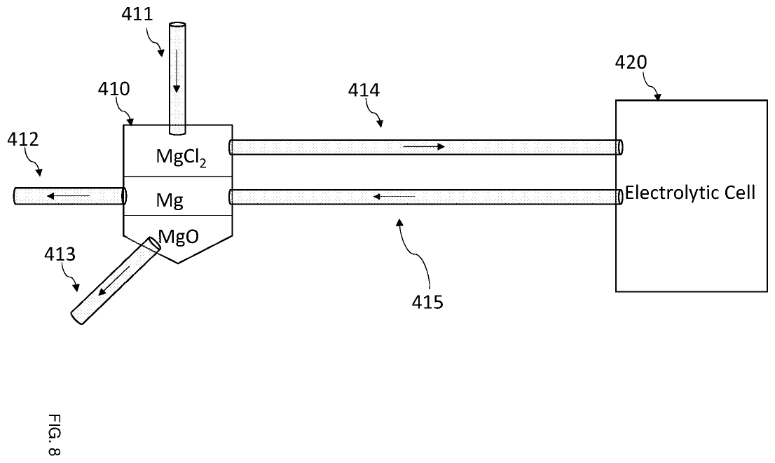

In another configuration shown in FIG. 8, The pre-treatment vessel and the separator comprise a single vessel that is initially charged with molten magnesium, either through the magnesium transfer inlet 415, or through inlet 411. After the desired temperature is achieved in the pre-treatment vessel 410, crude magnesium chloride along with any desired additives is added and the treatment reaction is allowed to proceed. Once the desired level of purity of the magnesium chloride or electrolyte mix is achieved, the electrolytic grade magnesium chloride, along with any other desired additives is directed into the electrolytic cell 420 through transfer outlet 414. As magnesium metal is produced in cell 420, it is pumped into the pre-treatment vessel 410 to supply fresh getter metal to the purification reaction, and the excess magnesium is collected from pre-treatment vessel 410 as product. The rates of crude magnesium chloride and additives is controlled to achieve the desired level of purification under the prevailing purification reaction conditions. In some cases, the initial charge of vessel 410 may comprise electrolytic grade magnesium chloride and any desired additives such the flow of electrolyte to the electrolytic cell may begin immediately. In some cases, the additives may be added directly to the electrolytic cell 420 so that only crude or electrolytic grade magnesium chloride is added to the vessel 410. The undesired by-products of the purification reaction may be removed from the bottom of the pre-treatment vessel 410 as they form, or periodically, through outlet 413. In this configuration, the ratio of magnesium chloride and magnesium may be between about 0.1%: 99.9% and about 99.9%: 0.1%. In FIGS. 5, 6, 7 and 8, the amount of hydrogen chloride will vary according to the efficiency of the conversion of conversion of oxygenated metal species to their respective chlorides. As the process proceeds, magnesium metal is removed through outlet 412. The agitation may be performed with stirrers, impellors, shakers, magnetohydrodynamic pumps, venturi nozzles or physical displacers. The agitation may also be performed by back-and-forth transfer between dual treatment vessels using gas pressure, pumps, or gravity. A venturi may be placed between the treatment vessels to enhance dispersion and mixing of the molten getter metal with the magnesium chloride or electrolyte mix.

In some embodiments, mixing may be accomplished by spraying a two-phase mixture of the molten electrolyte or molten magnesium chloride through a nozzle that directs the stream to the top of the purification vessel or directly into the separator. In some embodiments, a venturi nozzle may be used to effect the mixing by injecting the molten getter metal into a high velocity stream of molten electrolyte or molten magnesium chloride. In some embodiments, a venturi nozzle may be used to provide for the mixing by injecting the molten getter metal into a high velocity stream of molten electrolyte or molten magnesium chloride. In some embodiments, a venturi nozzle may be used to provide for the mixing by injecting the molten electrolyte or molten magnesium chloride into a high velocity stream of molten getter metal. In some embodiments, the purification reaction may be conducted for about 10 sec, 20 sec., 30 sec., 1 min., 5 min., 10 min., 20 min., 30 min., 40 min., 50 min., 1 h., 2 h., 5 h, 10 h., 15 h., 20 h.25 h., or within a range between two of the values herein. While called a “dehydration vessel” here, the purification reaction taking place when used to purify a mixture comprising anhydrous magnesium chloride, magnesium hydroxychloride and magnesium oxide is technically a dehydrochlorination reaction, as hydrogen chloride is expelled and the magnesium hydroxychloride is converted to magnesium oxide without the evolution of water. It is to be understood that the term “dehydration vessel” is not limiting in that respect, and the term is used for convenience. In some embodiments, instead of an initial charge of molten salt or electrolyte, the dehydration vessel may be initially charged from about 20% to 95% of capacity with the molten getter metal. In the foregoing embodiment where the dehydration vessel is initially charged with molten metal, the dehydration, dehydrochlorination, and gettering reactions occur concurrently, and in this case, the crude metal salt or electrolyte mix may be introduced as a solid, partially molten composition, or fully molten composition. In the case where a process described herein is conducted in a continuous rather than batch mode, the first and second time periods should be construed as residence times. In a preferred embodiment, the addition of the crude salt or salt mixture is effected by a direct addition to the initial molten charge in the dehydration vessel, without the use of an intermediate launder or venturi mixer. In some embodiments, the purification reaction may be conducted in a continuous fashion with the residence time of about 10 sec, 20 sec., 30 sec., 1 min., 5 min., 10 min., 20 min., 30 min., 40 min., 50 min., 1 h., 2 h., 5 h, 10 h., 15 h., 20 h., 25 h., or within a range between two of the values herein.

In certain aspects, the molten getter metal may be injected under high pressure into the molten crude magnesium chloride or molten crude electrolyte mix through a nozzle to create a fine dispersion of metal to provide agitation and large reactive surface area. Alternatively, a bubbler, or a bubbler containing an air-lift tube may be used to pass a gas such as argon, chlorine, or sulfur hexachloride to aid in mass transfer. Alternatively, the pre-treatment vessel may be a flow vessel packed with getter metal oxide pellets to promote crystallization of the getter metal produced during the purification process, thereby obviating the need for a distinct separator.

Mass transfer can also be enhanced in the pre-treatment vessel by temperature differential induced flow. The aforementioned modalities may be used singly or in combination. Separating the getter metal oxide from the purified molten magnesium chloride or purified molten electrolyte mix may be accomplished by settling, coagulation, hydrocyclones, centrifugation, baffled tank crystallizers, filtration through metal or ceramic meshes, sintered structures or sieves. With either alternative process, the hydrogen and hydrochloric acids generated during the purification process may be used to generate calcium chloride from various calcium containing minerals such as calcium hydroxide or calcium carbonate to be use for sulfate removal processes for treating brines.

The getter metal oxides recovered from the purification process may be further processed into salt forms, particularly with the co-generated hydrogen chloride. The getter metal oxides recovered from the purification process may be further processed for utilization in enhanced ocean alkalinity enhancement systems, examples of which are described in the US provisional patent application titled “Hydroxychloride Salt Ocean Alkalinity Enhancement”, PCT/US2023/072358, which is hereby incorporated specifically in their entirety by reference.

In some embodiment, the present technology may be used to purify metal salts other than magnesium chloride, such as CaCl₂), LiCl, SrCl₂, AlCl₃, ZrCl₄, BeCl₂, K₂Zr₂Cl₆, Na₂ZrCl₆, FeCl₂ or FeCl₃.

Typically, the magnesium salt is a magnesium halide, more typically, the magnesium salt is magnesium chloride.

In one embodiment, brines may be seawater, geothermal brines, effluents from desalination systems, solar ponds, potash brines, bitterns, or waste streams. In another embodiment, the brines may be synthetic brines.

Typically, synthetic brines may be effluents from industrial chemical processes such as desalination plants or any other process that produces an aqueous stream comprising dissolved or suspended magnesium compounds. Thereby, in one embodiment, the present technology provides for the production of purified electrolytes initially made from crude magnesium chloride that are equal or better in performance than electrolytes made directly from electrolytic grade magnesium chloride by contacting a molten electrolyte comprising crude magnesium chloride with a getter metal, removing the undissolved solids, and recovering electrolytic grade magnesium chloride from the melt.

In one embodiment, when the getter metal is magnesium, the unreacted getter metal may be retained in the electrolyte mixture and the mixture may be transferred to the electrolytic cell for magnesium metal production after removal of the getter metal oxides.

Electrolytic cell maintenance includes cleaning the cell from sludge, replacing or repositioning the anode or any other component. Electrolytic efficiency refers to the number of moles of magnesium metal produced per coulomb of electricity passed through the cell or the energy consumption per mole of magnesium.

The term “better or equal in performance” means that the electrolytes made using the present technology require no more and ideally less maintenance of the electrolytic cells, provide for equal or better electrolytic efficiency than those electrolytes made from electrolytic grade magnesium chloride.

In some embodiments, the crude magnesium chloride is obtained from a natural, or natural source derived brine. In some embodiments, the crude magnesium chloride is obtained from a synthetic brine.

In one embodiment, the electrolyte is made up of a salt mixture initially consisting, by weight, of about 5 to 30 percent crude magnesium chloride or electrolytic grade magnesium chloride, about 50 to 80 percent potassium chloride, and about 0 to 20 percent sodium chloride. In another embodiment, the electrolyte is made up of a salt mixture initially consisting, by weight, of about 5 to 85 percent crude magnesium chloride or electrolytic grade magnesium chloride and about 15 to 95 percent sodium chloride. In another embodiment, the electrolyte is pure magnesium chloride. The components other than magnesium chloride are typically called additives and are added to the electrolyte mix to adjust the melting temperature of the electrolyte mix, promote the coalescence of the magnesium metal, to prevent deposition of magnesium oxide on the magnesium metal during electrolysis, or to generally promote the operation of the electrolytic cell.

In one embodiment, the getter metal reaction may take place in the crude magnesium chloride, or in a mixture of crude magnesium chloride and additives. Typical additives include, but are not limited to sodium chloride, potassium chloride, calcium chloride, vanadium pentoxide, iron chloride, and fluoride metal salts.

In one embodiment, the purified electrolyte comprises no added fluoride.

In other embodiments, an electrical potential with respect to the molten electrolyte is applied or induced in the getter metal.

In some embodiments, the getter metal is selected from the group consisting of iron, aluminum, zinc, tin, and copper, calcium, and sodium or a combination thereof. In some embodiments, the getter metal may be vanadium, zirconium, titanium, or compounds thereof. In embodiments where the getter metal is a metal hydride, zirconium or vanadium, the purification reaction is conducted at a temperature less than the melting point of the getter metal. In one embodiment, the getter metal is magnesium, and the electrolyte purification process does not comprise electrolysis. In one embodiment, the getter metal is a magnesium alloy. In other embodiments, the getter metal is an alloy comprising a metal selected from the group consisting of iron, aluminum, zinc, tin, sodium, calcium and copper, zirconium, or a combination thereof. In one embodiment the getter metal comprises calcium. In one embodiment the getter metal is calcium. In still another embodiment, the getter metal comprises aluminum dust. In one embodiment, the getter metal is magnesium scrap.

In one embodiment, the electrolyte purification process does not comprise an electrolysis. In another embodiment, the electrolyte purification process comprises electrolysis when the getter metal is not magnesium.

In a preferred embodiment, the getter metal is not magnesium. In some embodiments, the getter metal is in the form of ingots, plates, sheets, foils, granules, powder, or dust. In a still even more preferred embodiment, the getter metal is aluminum. In some embodiments, the getter metal is powdered aluminum. In some embodiments, the getter metal is aluminum dust. In still other embodiments, the getter metal is aluminum scrap that is a byproduct of aluminum machining, sanding, or polishing. In one embodiment, when the getter metal is magnesium, the magnesium getter metal is introduced into the purification vessel as a suspension of molten magnesium in molten electrolyte from the electrolytic cell.

In another embodiment, about 0.01 to 1% of the magnesium from the electrolytic cell is transferred to the purification vessel. In another embodiment, about 100% of the magnesium metal produced in the electrolytic cell is transferred to the purification vessel and the unreacted magnesium is then collected for use.

In some embodiments, the getter metal is a metal hydride. In other embodiment, the getter metal comprises a metal hydride. In some embodiments, the metal hydride may be calcium hydride, lithium aluminum hydride, nickel hydride, zirconium hydride, or magnesium hydride.

In another embodiment, the electrolyte or magnesium chloride purification process may be conducted at about 100° C., 120° C., 140° C., 160° C., 180° C., 200° C., 250° C., 300° C., 350° C., 400° C., 450° C., 500° C., 550° C. or 600° C. In another embodiment, the electrolyte or magnesium chloride purification process may be conducted at between 100° C. to 150° C., 150° C. to 200° C., 200° C. to 250° C., 250° C. to 300° C., 300° C. to 350° C., 350° C. to 400° C., 400° C. to 450° C., 450° C. to 500° C., 500° C. to 550° C., 550° C. to 600° C., 600° C. to 650° C., 650° C. to 700° C., 700° C. to 750° C., 750° C. to 800° C., 800° C. to 900° C., 900° C. to 1000° C., 1000° C. to 1100° C., 1100° C. to 1200° C., 1200° C. to 1500° C. or 1500° C. to 2000° C. In another embodiment, the electrolyte or magnesium chloride purification process may be conducted at about 650° C., 700° C., 750° C., 800° C., 850° C., 900° C., 950° C., 1000° C., 1100° C., 1200° C., 1300° C., 1400° C., 1500° C., 1600° C., 1700° C., 1800° C., 1900° C., or 2000° C. In another embodiment, the electrolyte or magnesium chloride purification process may be conducted at about 0.1 bar, 0.2 bar, 0.3 bar, 0.4 bar, 0.5 bar, 0.6 bar, 0.7 bar, 0.8 bar, 0.9 bar, or 1 bar. In another embodiment, the electrolyte or magnesium chloride purification process may be conducted at about 1.5 bar, 2 bar, 3 bar, 4 bar, 5 bar, 6 bar, 7 bar, 8 bar, 9 bar, or 10 bar.

In some embodiments, the electrolyte purification may be conducted under an inert atmosphere such as, but not limited to argon.

### Example 9

The oxide contents of the samples taken from the described experiments are measured via a set of in-house techniques. The oxide contents can be calculated by a variety of methods, but due to the alkalinity of these species are most commonly obtained by titration of the salt samples with hydrochloric acid. MgO requires two units of HCl for neutralization and MgOHCl requires only a single unit of HCl for neutralization. The relative quantities of MgO and MgOHCl can then also be obtained in a variety of ways such as carbothermic reduction, as explained in various literature reports. The first set of experiments conducted were designed to investigate the general efficacy of the magnesium gettering process. A set of molten salts were prepared, and half of them were subjected to the addition of magnesium metal. The candidate salts were prepared by mixing pre-prepared anhydrous quantities of sodium chloride and magnesium chloride to a desired composition and fusing (melting) the electrolyte at approximately 670 deg.C. Molten salts with compositions of 25% MgCl₂, 50% MgCl₂ and 75% MgCl₂ were prepared—with the balance of the mass being made up by NaCl. This electrolyte was then subjected to the addition of hydrated salts which yielded a molten mixture of MgCl₂, NaCl, MgO, and MgOHCl. The experimental procedure is described as follows: A mixture of anhydrous MgCl₂ and NaCl was added by funnel to a quartz crucible at atmospheric temperature. This was warmed in a lab furnace to 670° C., where it remained for the whole experiment. After complete melting of the salt mixture, the dosing process of hydrated MgCl₂ salt began. It is important to note that this material, made in-house, contains a small amount (1-6%) of MgOHCl. 1.5 g batches were added every 2 minutes for a total of 30 g. No stirring was conducted between additions. After allowing 40 minutes for the MgO species in the molten salt to settle, a 0.5 g quantity of magnesium metal was added to the clarified supernatant electrolyte to react with any dissolved MgOHCl species. A reaction would visibly occur at this point, occasionally generating orange flashes of flame. This system was then left to stand for 2 hours with stirring every 30 minutes. After the system had been left standing, and visible oxide impurities had completely separated to the bottom of the crucible, the clarified molten salt electrolyte was decanted into a sample holder for cooling. The sample was allowed to cool in a dry box to prevent water pick-up of the hygroscopic salt during cooling.

For a second set of experiments, the gettering process was carried out similarly, but with some notable differences. Firstly, the composition of the initial anhydrous electrolyte was selected to be roughly 30% MgCl₂ and 70% NaCl, being modified via the addition of hydrated salts to ˜50% MgCl₂. Secondly, the gettering process was conducted under gas agitation via the insertion of a bubbling tube into the melt. Thirdly and finally, the MgO layer was not allowed to settle before sampling. These changes were implemented in order to provide us data on an electrolyte of specific interest, determine the process sensitivity to agitation methods, and give us greater insight into the mechanism of the gettering process. The deliberate mixing of the molten salt with the solid oxide particles prior to sampling ensured that the entire quantity of oxide-containing impurities (including those that would have separated to the bottom of the melt) were measured and thereby conclusions could be drawn about the elimination of MgOHCl from the entire system.

### Observations and Results

Some observations from the experiments were general to all experiments conducted and are discussed here. Upon addition of magnesium to the melt, the metal particle rapidly melts, forming a spheroidal shape and floating to the top of the melt. The reaction induced by the addition of magnesium is obvious visually and seems to be most active initially when it is introduced to the unpurified melt and also as it is stirred. Upon addition of the magnesium, there is an audible crackling of deflagrations occurring on the surface of the melt that are accompanied by an orange color. The reaction occurring has been ascribed to the contacting of hydrogen gas, released by bubbles formed on the surfaces of the Mg droplets, with the air above the experimental system.

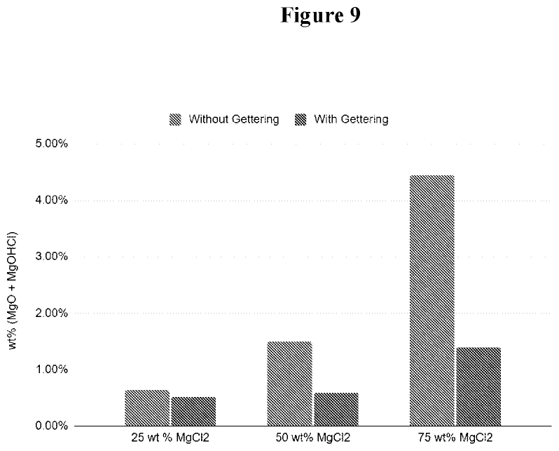

Regarding the analytical results of the first set of experiments, there was a measurable decrease in the weight percentage of oxygen-containing species in the clarified electrolyte between the samples with and without Mg gettering. FIG. 9 compares the results with and without Mg gettering with all other reaction parameters constant. The relative fraction of MgO and MgOHCl in the clarified electrolyte was not measured for these runs, and thereby a assumption was made that the relative fraction MgO and MgOHCl would be the same in all cases. This fractions of oxide-containing compounds were assumed to be 23% MgOHCl and 77% MgO, based on data from similar work. The data presented above suggests the efficacy of the Mg gettering process. The plot shows that the mass of oxygen-containing species in the clarified electrolyte is between 20-70% lower in the samples that were subjected to magnesium addition than those that were not. Notably, the fraction of oxide-containing impurities is higher in the electrolytes with a higher magnesium chloride content, and the effect of the magnesium gettering was more substantial. While not wishing to be bound by theory, we believe that as electrolytes with greater fractions of 2″ ions stabilize and solubilize oxide species to a greater extent. Given the above, the data suggest that the addition of Mg metal was able to assist the purging of the clarified electrolyte of oxide-containing species in all cases, presumably by converting them into MgO and causing them to separate to the layer of solids at the bottom of the vessel. Regarding the second set of experiments, where magnesium gettering was performed under gas agitation, the objective was slightly different. As discussed previously, instead of attempting to purify the clarified electrolyte and demonstrate our ability to produce very low contents of oxide impurities in the samples, the desire was to show that the MgOHCl in the total system, including the settled solids layer, could be reduced. This would support the conclusion that the MgOHCl impurities were indeed being converted into MgO species, rather than just being relocated to the settled solids layer beneath the electrolyte by some other mechanism.

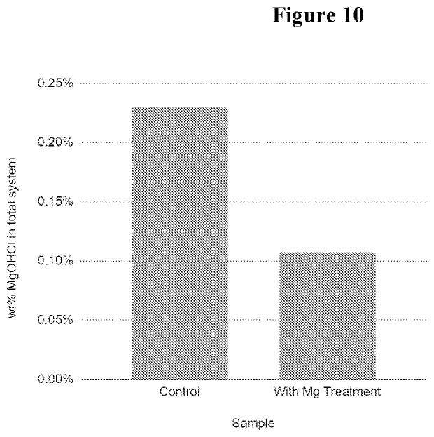

The results of the second experimental set are shown below in FIG. 10. One control sample was prepared, without any magnesium gettering, and three repeat experiments were carried out on samples with magnesium gettering. The data show again that there is a substantial reduction in the quantity of magnesium hydroxychloride present in the samples after gettering. However, in this case and differently to the data represented in FIG. 9, the samples represent the entire contents of the molten salt and oxide system. This data confirms that the action of the magnesium on the system is to attack hydroxychloride species, likely degrading them into MgO, MgCl₂ and H₂ gas as per equation (1).

### Example 10

### Analytical Methods

The sulfate contents of the samples taken from the described experiments are measured via a set of techniques. Ion chromatography (IC) and inductively coupled plasma with optical emission spectroscopy (ICP-OES) analyses were used to verify the sulfate and sulfur contents of the samples after dissolving the salts in water and/or acid.

### Experimental Procedure

The first set of experiments conducted were designed to investigate the general efficacy of the magnesium gettering of sulfate process. A set of molten salts were prepared, and half of them were subjected to the addition of magnesium metal. The candidate salts were prepared by mixing pre-prepared anhydrous quantities of sodium chloride and magnesium chloride to a desired composition and fusing (melting) the electrolyte at approximately 720° C. All molten salts were prepared with a mixture containing 55 wt. % MgCl₂, the remainder being NaCl. This electrolyte was then subjected to the addition of sodium sulfate Na₂SO₄) yielded a molten mixture of MgCl₂, NaCl, MgO, MgOHCl, and MgSO₄. The experimental procedure is described as follows: A mixture of 165 grams of anhydrous MgCl₂ and 135 g of anhydrous NaCl was added to a quartz crucible at atmospheric temperature. This was heated in a lab furnace to 720° C., where it remained for the whole experiment. After complete melting of the salt mixture and a waiting period of 10 minutes to ensure uniform heating, the desired amount of Na₂SO₄ (either 3.5 wt % or 0.35 wt %) was added to the melt and mixed thoroughly with a dry glass stirring rod. After allowing 10 minutes for the sulfate species in the molten salt to dissolve, in the gettering experiments a 1 g quantity of magnesium metal was added to the clarified supernatant electrolyte to react with any dissolved sulfate species (corresponding to 0.55:1 and 5.5:1 molar equivalence of Mg:SO₄, respectively, for the high and low concentrations of SO₄²⁻ tested). A reaction would visibly occur at this point, generating blue-orange flames and a froth at the top surface of the melt. When agitated, the bubbles in the froth would burst and burn in a blue-orange colored flame. The melt was stirred every 5 minutes for a total of 20 minutes, then given 10 minutes to settle. After the insoluble impurities had completely separated to the bottom of the crucible, the clarified molten salt electrolyte was decanted into a sample holder for cooling. 5 minutes later, the insoluble solids were poured into a separate sample holder. The samples were allowed to cool in a dry box to prevent any further hydration from occurring. Each sample was analyzed separately, and their data re-combined for overall analysis.

Besides the addition of Mg metal, the only experimental parameter varied in these experiments was the amount of sodium sulfate introduced. Originally, a relatively large amount of sodium sulfate was introduced, and there was a possibility that the sulfate exceeded its solubility limit in the chloride melt. In this case, there is a possibility for the precipitated sulfate on the bottom of the crucible to redissolve in solution once the dissolved sulfate was removed via reaction, referred to as a “replenishing” reaction. To remedy this, two experiments were performed with a smaller amount of sodium sulfate introduced, so that there would be no excess of sodium sulfate compared to its solubility limit.

### Observation and Results

Some observations from the experiments were general to all experiments conducted and are discussed here. Upon addition of magnesium to the melt, the metal particle rapidly melts, forming a spheroidal shape and floating to the top of the melt. The reaction induced by the addition of magnesium is obvious visually and seems to be most active initially when it is introduced to the unpurified melt and also as it is stirred. Upon addition of the magnesium, there was a visible froth forming at the surface of the melt. The bubbles, when popped, burned in a blue flame which became orange as it rose. This flame was not accompanied by an obvious audible noise, unlike earlier experiments that were believed to exhibit hydrogen gas evolution. The presently discussed reaction has been ascribed to the contacting of sulfur gas, released by bubbles formed on the surfaces of the melt, with the air above the experimental system.

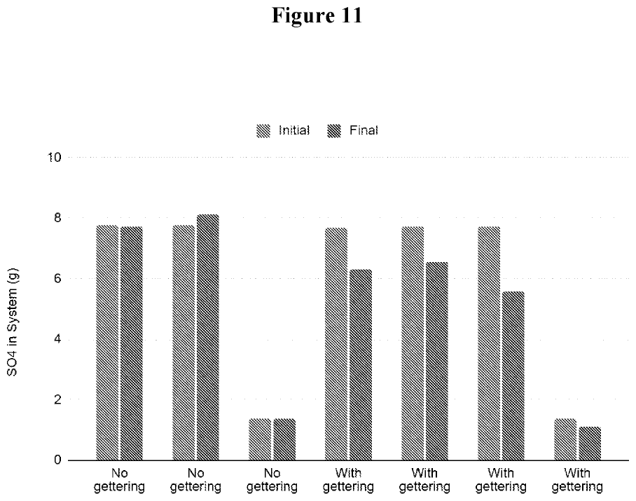

Regarding the analytical results of the first set of experiments, there was a measurable decrease in the weight percentage of sulfate-containing species in the samples with Mg gettering. FIG. 11 compares the results with and without Mg gettering with all other reaction parameters constant. The initial and final amount of sulfates in the total system (including both settled solids or “sludge” and clarified electrolyte) were compared. A baseline experiment was performed to determine the amount of sulfate present in the melt before the addition of sodium sulfate; this amount was assumed to be constant for all other runs, given the same feedstocks, procedure.

The data presented in FIG. 11 demonstrates the efficacy of the process of gettering sulfate with Mg metal. The plot shows that the total mass of sulfate-containing species in the final sample is between 15-30% lower in the samples that were subjected to magnesium addition than those that were not. The data suggest that the addition of Mg metal was able to reductively destroy some quantity of sulfates in all cases, presumably by converting sulfate into elemental sulfur (thereby causing sulfur to exit the system into the gas phase) or magnesium sulfide (in which case hydrogen sulfide would be formed in subsequent wet digestion and thereby also exit to the gas phase). It was found that the percentage of sulfates removed from the system were roughly equivalent in all cases, regardless of whether the system was provided with a large amount of starting sulfate or a relatively smaller amount. The data show that the sulfate ions are being transformed into sulfides or elemental sulfur and either leaving the experimental reaction chamber or becoming inert to our sulfate precipitation analysis.

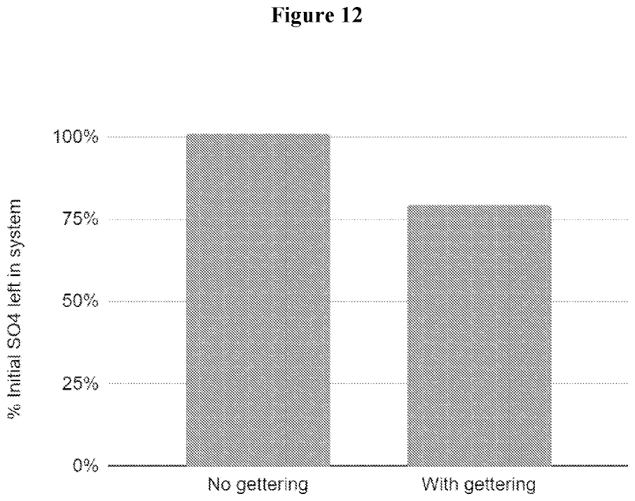

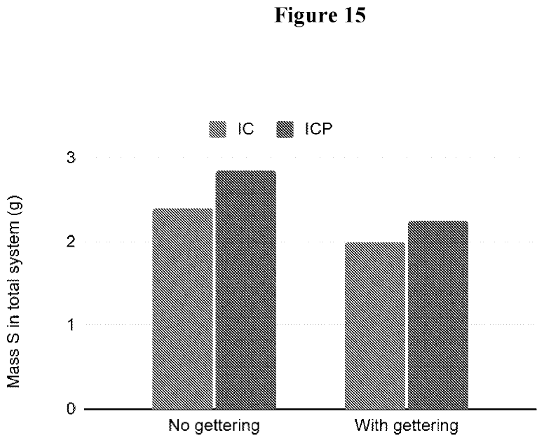

That said, regardless of the reaction mechanism, the results still provide conviction that a significant quantity of sulfate is being purged from the electrolyte system with gettering in all tested cases. In FIG. 12, a summary of the gettering results are shown again below as an average percentage reduction in the SO₄²⁻-content. Without introduction of Mg metal, there was effectively no change in SO₄²⁻-content observed. When gettering was performed, however, an average SO₄²⁻ mass loss of 20% was observed. Inductively-coupled plasma optical emission spectroscopy (ICP-OFS, referred to here as ICP) analysis was also performed. This test was done in the hope of determining whether the ‘invisibility’ of sulfides to previous analytical techniques was skewing the results. Unlike ion chromatography (IC), ICP is not just sensitive to sulfate quantities and is instead sensitive to the total amount of sulfur in the system. As such, the difference between the IC and ICP results should theoretically give some indication to the relative quantities of sulfides and sulfates in the system. These measurements showed that the sulfur content in the sample was higher than what would be attributable to solely sulfate quantities. These ICP results are compared with the ion chromatography results in FIG. 15 below. Because of this, if there is no systemic error between the methods, it is plausible that 10-20% of the sulfur exists in a non-sulfate form (e.g., MgS, Na₂S). Whether or not the speciation of the sulfur in the electrolyte is resolvable in this way, it is again seen that the quantity of sulfur in the system has been reduced by the gettering process. The evidence presented is thereby conclusive: magnesium addition results in reduction of sulfur quantities in molten salt electrolytes, evolving significant quantities of sulfur to the gas phase and plausibly also to a magnesium sulfide phase within the electrolyte.

A person skilled in the art appreciates that these non-limiting examples are but just several ways of implementing and integrating the magnesium chloride or aluminum chloride dehydration and precipitate separation operations disclosed herein.

Unless defined otherwise, all technical and scientific terms used herein have the same meaning as is commonly understood by one of ordinary skill in the art to which the inventions belong. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet. Reference thereto evidences the availability and public dissemination of such information.

1. A method of dehydrating magnesium chloride hydrate bearing from about 0.01 to 6 waters of hydration comprising:
a) adding said magnesium chloride hydrate to a molten salt composition comprising anhydrous magnesium chloride over a first time period to obtain a mixture;
b) holding the mixture for a second time period; and
c) separating the precipitated solids from the mixture;
thereby obtaining a molten salt composition enriched in anhydrous magnesium chloride.

2. The method of claim 1, wherein the first time period is from about 10 min to 60 min.

3. The method of claim 1 or 2, wherein the second time period is from about 5 min to 240 min.

4. The method of claim 1, wherein the first time period is from about 10 min to 60 min and the second time period is from about 5 min to 240 min.

5. The method of any one of claims 1 to 4, wherein the mass of added magnesium chloride hydrate is from about 0.001 to 0.5 times the mass of the molten salt composition.

6. The method of any one of claims 1 to 4, wherein the mass of added magnesium chloride hydrate is from about 0.001 to 0.5 times the mass of the molten salt composition and the first time period is from about 10 min to 60 min.

7. The method of any one of claims 1 to 4, wherein the mass of added magnesium chloride hydrate is from about 0.001 to 0.5 times the mass of the molten salt composition, the first time period is from about 10 min to 60 min, and the second time period is from about 5 min to 240 min.

8. The method of any one of claims 1 to 7, further comprising transferring the mixture to a separating vessel before holding the mixture for the second time period.

9. A process for purifying a molten electrolyte comprising magnesium chloride, the process comprising:
c) contacting the molten electrolyte with a getter metal selected from the group consisting of calcium, aluminum, zinc, tin, copper, magnesium, manganese, iron and sodium; and
d) removing the insoluble materials;
thereby obtaining a purified molten electrolyte.

10. The process of claim 9, wherein the molten electrolyte is molten crude magnesium chloride.

11. The process of claim 9 or 10, wherein the getter metal is a magnesium or magnesium alloy getter metal at a temperature at or above its melting point.

12. The process of claim 11, wherein the molten getter metal is maintained in the form of a globular suspension during at least one part of the purification process.

13. The process of claim 12, wherein the purification reaction takes place within an electrolytic cell used for magnesium production.

14. The process of claim 12, wherein the getter metal has not been initially produced by the electrolytic cell.

15. The process of claim 11, wherein the purified molten electrolyte comprises between about 5 ppm and 750 ppm sulfate by weight.

16. The process of claim 11, wherein the purified molten magnesium chloride comprises between about 5 ppm and 750 ppm sulfate by weight.

17. A method of dehydrating aluminum chloride hydrate bearing from about 0.01 to 6 waters of hydration comprising:
d) adding said aluminum chloride hydrate to a molten salt composition comprising anhydrous aluminum chloride over a first time period to obtain a mixture;
e) holding the mixture for a second time period; and
f) separating the precipitated solids from the mixture;
thereby obtaining a molten salt composition enriched in anhydrous aluminum chloride.

18. The method of claim 17, wherein the first time period is from about 10 min to 60 min.

19. The method of claim 17 or 18, wherein the second time period is from about 5 min to 240 min.

20. The method of claim 17, wherein the first time period is from about 10 min to 60 min and the second time period is from about 5 min to 240 min.
